(19) United States
(12) Patent Application Publication
(10) Pub. No.: US 2019/0039838 A1
(43) Pub. Date: Feb. 7, 2019

(54) ROBOTIC GRIPPER FOR HANDLING MEAT PRODUCTS

(71) Applicant: Soft Robotics, Inc., Cambridge, MA (US)

(72) Inventors: Jeffrey CURHAN, Warwick, RI (US); Thomas WOMERSLEY, Newton, MA (US); Joshua Aaron LESSING, Cambridge, MA (US)

(21) Appl. No.: 16/053,213

(22) Filed: Aug. 2, 2018

Related U.S. Application Data
(60) Provisional application No. 62/540,747, filed on Aug. 3, 2017.
(60) Provisional application No. 62/542,059, filed on Aug. 7, 2017.

(51) Int. Cl. B65G 47/90; B25J 15/06; B25J 15/00

(52) U.S. Cl. CPC B65G 47/908; B65G 2201/0202; B25J 15/0023; B25J 15/0616

(57) ABSTRACT

Robotic grippers have been employed to grasp and manipulate target objects. One task posing relatively unique problems is the handling of meat products, which can be difficult to grasp with a conventional gripper due to the surface texture and malleability of the meat, among other factors. Exemplary embodiments described herein provide robotic grippers having one or more fingers and a plate, the plate optionally providing suction capabilities. The actuators apply a small force to the edges of the grasping target. In suctioned embodiments, an array of suction holes within the plate support the center of the grasping target by applying a light vacuum force at many points along the surface thereof In non-suctioned embodiments, the actuators grip the edges of the grasping target and the plate makes conformal contact with the grasping target to prevent it from folding or otherwise deforming or disintegrating from the gripping force of the actuators.

### RELATED APPLICATIONS

This application claims priority to U.S. Provisional Application No. 62/540,747, filed Aug. 3, 2017 and to U.S. Provisional Application No. 62/542,059, filed Aug. 7, 2017. The contents of the aforementioned applications are incorporated herein by reference.

### FIELD OF THE DISCLOSURE

The disclosure relates generally to the field of robotics and particularly to novel structures for gripping meat products, particularly relatively flat, planar meat products.

### BACKGROUND

Robotic grippers have been employed to automate many tasks by grasping and manipulating items. One task posing relatively unique problems is the handling of meat products, such as ground meat patties, cutlets, etc. These meat products can be difficult to grasp with a conventional gripper due to the surface texture and malleability of the meat, among other factors.

In addition, many meat products (particularly ground meat patties) are relatively planar or disc-shaped. As a result, it can be relatively difficult to secure a strong grasp along the edges of the product alone, and even if a strong grasp is obtained, there is a risk of folding or crumpling the product. One possible solution is to apply a suction cup to the center of the target to be grasped, but in the case of a planar meat product a suction cup is relatively ineffective for several reasons. For example, a suction cup is often applied only at one location. The opening through which suction is applied must therefore be relatively large in order to apply sufficient suction force; however, such a large opening may suck in parts of the meat product such as chunks of ground meat, skin, etc., and even if part of the object is not pulled into the cup, the vacuum force of the cup may still deform the surface and create a lasting, visible mark on the product.

Moreover, a suction cup only applies a force to a relatively small area in the center of a patty, which may not result in a significant enough force to assist in the gripping of the product. Moreover, the patty may bow in towards the center as the suction is applied, causing further difficulties for a gripper attempting to grip the patty from the edge.

Some meat products are shipped with pieces of paper, such as wax paper, separating the products (e.g., hamburger patties may be separated in this manner). When lifting the meat product with a robotic gripper, the paper may or may not be stuck to the surface of the meat product. If the paper accompanies the meat product during a picking action by the grasper, the paper must somehow be removed before the meat product is delivered to a location such as a grill or oven.

Still further, meat products may be provided to a first location in a variety of orientations. When a robotic gripper approaches the first location to grasp the meat product, the different possible orientations may make it difficult to secure a strong grip.

### SUMMARY

Embodiments of the present invention are addressed to the problems with handling target objects, and especially meat products, described above. It should be noted that although the present invention is described with reference to the handling of meat products, embodiments of the present invention are equally applicable to the handling of other grasping targets that are planar and compliant, or otherwise have properties similar to meat products.

In general, embodiments of the present invention comprise actuators (also referred to herein as “fingers”) and a plate. In some embodiments, the plate is a suction plate. Such embodiments combine a set of soft actuators with a plate having a distributed array of suction holes. The actuators apply a small force to the edges of the grasping target while the array of suction holes within the plate support the center of the grasping target by applying a light vacuum force at many points along the surface thereof. Such embodiments are well-suited to handle grasping targets with flaky and/or viscous materials that are susceptible to surface damage, such as by applying too strong a grip with fingers, and/or by applying a concentrated force to the grasping target with a suction cup.

In other embodiments, the plate does not make use of suction, and may be referred to herein as a bumper plate. Such embodiments are well-suited to handle grasping targets that are less likely to crumble or otherwise disintegrate during the handling process, but are nonetheless thin, flexible or otherwise cannot support their own weight, such as a rubber sheet or thin meat product. In these embodiments, the actuators grip the edges of the grasping target and the plate makes conformal contact with the grasping target to prevent it from folding or otherwise deforming or disintegrating from the gripping force of the actuators.

Examples of meat products that may be grasped and handled with embodiments of the present invention include ground patties, cuts, steaks, fillets and other pieces of beef, pork, fish, poultry and other meats. Other food-based grasping targets include uncooked dough, jello and other flexible or moldable food materials. Examples of grasping targets that may be grasped and handled with embodiments of the present invention that are not food-based include products made from hydrogel, unfired clay, uncured ceramic, mica, wet paper pulp, or uncured plaster, prepeg sheets, rubber (or other elastomeric) sheets, and uncured rubber preforms intended for compression molding.

Further exemplary embodiments, or aspects relating to embodiments of the invention, relate to improvements in soft robotic systems for transporting organic articles. For example, a soft robotic gripper may include at least two bendable members configured to apply a gripping force to the organic article, and a palm plate adjacent the two bendable members may include at least one of an astrictive or a contiguitive mechanism configured to apply an attractive force, biased toward the palm plate, upon the organic article. An ejection mechanism adjacent the two opposed bendable members may be configured to apply an ejection force, biased away from the palm plate, upon the organic article.

Optionally, a gripper hub may support the soft robotic gripper, palm plate, and/or ejection mechanism, and a fluid actuator fluidly connected to the at least two bendable members may cause the soft robotic gripper to open and close about the organic article. A motorized drive may be configured to relatively move the gripper hub and the organic article to be transported in at least one degree of freedom.

The palm plate may include an astrictive mechanism including a perforated air table connected to a fluid actuator capable of reducing fluid pressure through the air table to attract the organic article to the palm plate. Optionally, a spatula member may oppose the palm plate and be configured to scrape or support the organic article from a surface and to hold the organic article in a position to be gripped by the soft robotic gripper. A heat transfer mechanism supported by the gripper hub may be configured to change the temperature of the palm plate adjacent the organic article.

The ejection mechanism may further include a rigid ejection member configured to apply the ejection force directly to the organic article. A guide mechanism may hold the rigid ejection member in different base positions to support differing thickness organic articles held against the rigid ejection member by the soft robotic gripper. Alternatively, or in addition, a linkage may connect the rigid ejection member to move the rigid ejection member together with an opening motion of at least one of the two bendable members to apply the ejection force. Alternatively, or in addition, a fluid actuator may be configured to apply fluid force to the rigid ejection member to apply the ejection force. In certain cases, the rigid ejection member may penetrate through the palm plate and move relative to the palm plate to apply the ejection force.

Alternatively, or in addition, the rigid ejection member may include a pusher surface, the pusher surface being moved by the ejection mechanism to apply the ejection force. The pusher surface may include an astrictive mechanism including a perforated air table connected to a fluid actuator capable of reducing fluid pressure through the perforated air table to attract the organic article to the pusher surface. The pusher surface may include a flat surface having a surface area at least 50% of the surface area of the palm plate. The pusher surface may include a conformal surface having a contour substantially matching an expected general shape of an organic article to be gripped by the soft robotic gripper. The pusher surface may include relief surface having peaks configured to contact the organic article and valleys configured to maintain clearance between the pusher plate and the organic article. An astrictive mechanism may act at the peaks to attract the organic article.

Alternatively, or in addition, the ejection mechanism may include a flexible ejection member configured to apply the ejection force. A linkage may connect the flexible ejection member to move the flexible ejection member together with at least one of the two bendable members. Optionally, a mechanical actuator may act upon the flexible ejection member to bend the flexible ejection member to apply the ejection force, the mechanical actuator including at least one of a plunger, a swing arm, an eccentric cam, or a vibrating oscillator. Alternatively, or in addition, a conveyor may translate the flexible ejection member to apply the ejection force as a shearing force. At least one of an astrictive or a contiguitive mechanism may act via the flexible ejection member conveyed by the conveyor.

Alternatively, or in addition, the ejection mechanism may include a fluid actuator configured to apply fluid force to the flexible ejection member to apply the ejection force. Optionally, a strain limiting member may be integrated with the flexible ejection member and configured to cause the flexible ejection member to bend substantially as a whole under the fluid pressure to apply the ejection force. Alternatively, or in addition, a perforated member may be integrated with the flexible ejection member configured to cause the flexible ejection member to form convex protrusions in a plurality of locations under the applied fluid force to apply the ejection force. The fluid actuator may be further configured to apply a reduction in fluid pressure to cause the flexible ejection member to form concavities at the plurality of locations. Optionally, the ejection mechanism may include an accordion chamber that expands under the applied fluid force to apply the ejection force.

### BRIEF DESCRIPTION OF THE DRAWINGS

FIGS. 1A-1D depict various examples of soft robotic actuators.

FIGS. 2A-2B depict an exemplary meat gripper in accordance with the present disclosure.

FIG. 2C depicts an alternative embodiment in accordance with the present disclosure.

FIGS. 2D-2G depict exemplary geometries for a bumper plate suitable for use with the exemplary meat gripper.

FIG. 3A provides a detailed overview of an exemplary gripper.

FIG. 3B depicts a detailed view of an exemplary vacuum pad suitable for use with embodiments described herein.

FIG. 3C depicts an overview of an exemplary gripper in operation.

FIGS. 4A-4C depict examples of compliant mounts suitable for use with exemplary vacuum pads.

FIGS. 5A-5B depict an example of an adjustable height vacuum pad suitable for use with exemplary embodiments.

FIGS. 6A-6C depict various vacuum pad structures suitable for use with exemplary embodiments.

FIG. 7 depicts exemplary ports suitable for use with exemplary vacuum pads.

FIG. 8 depicts an exemplary structure allowing the vacuum pump to be cleaned.

FIG. 9 depicts an exemplary robotic arm including an end of arm tool according to an exemplary embodiment.

FIGS. 10A-10V depict exemplary release mechanisms suitable for use with the meat grippers described herein.

FIG. 11 depicts an example of controlling adhesion by heating or cooling the interface between the meat and the pad.

FIGS. 12A-12D depicts an exemplary object presentation station.

FIGS. 13A-13B depict an example gripper employing finger structures for securing meat.

FIG. 14 depicts an exemplary gripper employing proximity sensors.

FIGS. 15A-15C depicts an example of active location of grasp targets using a retention table.

FIG. 16 is a flowchart describing an exemplary grasping technique in accordance with exemplary embodiments.

### DETAILED DESCRIPTION OF THE PREFERRED EMBODIMENTS

The present invention will now be described more with reference to the accompanying drawings, in which preferred embodiments of the invention are shown. The invention, however, may be embodied in many different forms and should not be construed as being limited to the embodiments set forth herein. Rather, these embodiments are provided so that this disclosure will be thorough and complete, and will fully convey the scope of the invention to those skilled in the art. In the drawings, like numbers refer to like elements throughout.

### Background on Soft Robotic Grippers

Conventional robotic actuators may be expensive and incapable of operating in certain environments where the uncertainty and variety in the weight, size and shape of the object being handled has prevented automated solutions from working in the past. The present application describes applications of novel soft robotic actuators that are adaptive, inexpensive, lightweight, customizable, and simple to use.

Soft robotic actuators may be formed of elastomeric materials, such as rubber, coated fabric, or thin walls of plastic arranged in an accordion structure that is configured to unfold, stretch, twist, bend, extend and/or contract under pressure, or other suitable relatively soft materials. As an alternative or in addition to accordion structures, other types or configurations of soft actuators employing elastomeric materials may be utilized. They may be created, for example, by molding or bonding one or more pieces of the elastomeric material into a desired shape. Alternatively or in addition, different pieces of elastomeric material may be thermally bonded, or sewn. Soft robotic actuators may include a hollow interior that can be filled with a fluid, such as air, water, or saline to pressurize, inflate, and/or actuate the actuator. Upon actuation, the shape or profile of the actuator changes. In the case of an accordion-style actuator (described in more detail below), actuation may cause the actuator to curve or straighten into a predetermined target shape. One or more intermediate target shapes between a fully unactuated shape and a fully actuated shape may be achieved by partially inflating the actuator. Alternatively or in addition, the actuator may be actuated using a vacuum to remove inflation fluid from the actuator and thereby change the degree to which the actuator bends, twists, and/or extends.

Actuation may also allow the actuator to exert a force on an object, such as an object being grasped or pushed. However, unlike traditional hard robotic actuators, soft actuators maintain adaptive properties when actuated such that the soft actuator can partially or fully conform to the shape of the object being grasped. They can also deflect upon collision with an object, which may be particularly relevant when picking an object off of a pile or out of a bin, since the actuator is likely to collide with neighboring objects in the pile that are not the grasp target, or the sides of the bin. Furthermore, the amount of force applied can be spread out over a larger surface area in a controlled manner because the material can easily deform. In this way, soft robotic actuators can grip objects without damaging them.

Still further, soft actuators are adaptive, and accordingly a single fixture can grip multiple kinds of objects. Because the outer surfaces of soft actuators are relatively delicate, they can serve in roles such as redirectors for easily bruised or damaged items (e.g., tomatoes) whereas hard fixtures might be limited to manipulating more robust items (e.g., brass valves).

Furthermore, soft actuators will typically not mark the surface being gripped. Typically, when an easily-marked surface (e.g., a veneer) will be gripped by a hard fixture, a protective coating or film may be applied to prevent the part from being marked; this increases the cost of manufacturing. With a soft actuator, this step may be omitted and the part may be protected without a special coating or film.

Moreover, soft robotic actuators allow for types of motions or combinations of motions (including bending, twisting, extending, and contracting) that can be difficult to achieve with traditional hard robotic actuators.

Conventional robotic grippers or actuators may be expensive and incapable of operating in certain environments where the uncertainty and variety in the weight, size and shape of the object being handled has prevented automated solutions from working in the past. The present application describes applications of novel soft robotic actuators that are adaptive, inexpensive, lightweight, customizable, and simple to use.

Soft robotic actuators may be formed of elastomeric materials, such as rubber, or thin walls of plastic arranged in an accordion structure that is configured to unfold, stretch, and/or bend under pressure, or other suitable relatively soft materials. They may be created, for example, by molding one or more pieces of the elastomeric material into a desired shape. Soft robotic actuators may include a hollow interior that can be filled with a fluid, such as air, water, or saline to pressurize, inflate, and/or actuate the actuator. Upon actuation, the shape or profile of the actuator changes. In the case of an accordion-style actuator (described in more detail below), actuation may cause the actuator to curve or straighten into a predetermined target shape. One or more intermediate target shapes between a fully unactuated shape and a fully actuated shape may be achieved by partially inflating the actuator. Alternatively or in addition, the actuator may be actuated using a vacuum to remove inflation fluid from the actuator and thereby change the degree to which the actuator bends, twists, and/or extends.

Actuation may also allow the actuator to exert a force on an object, such as an object being grasped or pushed. However, unlike traditional hard robotic actuators, soft actuators maintain adaptive properties when actuated such that the soft actuator can partially or fully conform to the shape of the object being grasped. They can also deflect upon collision with an object, which may be particularly relevant when picking an object off of a pile or out of a bin, since the actuator is likely to collide with neighboring objects in the pile that are not the grasp target, or the sides of the bin. Furthermore, the amount of force applied can be spread out over a larger surface area in a controlled manner because the material can easily deform. In this way, soft robotic actuators can grip objects without damaging them.

Still further, soft actuators are adaptive, and accordingly a single fixture can grip multiple kinds of objects. Because the outer surfaces of soft actuators are relatively delicate, they can serve in roles such as redirectors for easily bruised or damaged items (e.g., tomatoes) whereas hard fixtures might be limited to manipulating more robust items (e.g., brass valves).

Furthermore, soft actuators will typically not mark the surface being gripped. Typically, when an easily-marked surface (e.g., a veneer) will be gripped by a hard fixture, a protective coating or film may be applied to prevent the part from being marked; this increases the cost of manufacturing. With a soft actuator, this step may be omitted and the part may be protected without a special coating or film.

Moreover, soft robotic actuators allow for types of motions or combinations of motions (including bending, twisting, extending, and contracting) that can be difficult to achieve with traditional hard robotic actuators.

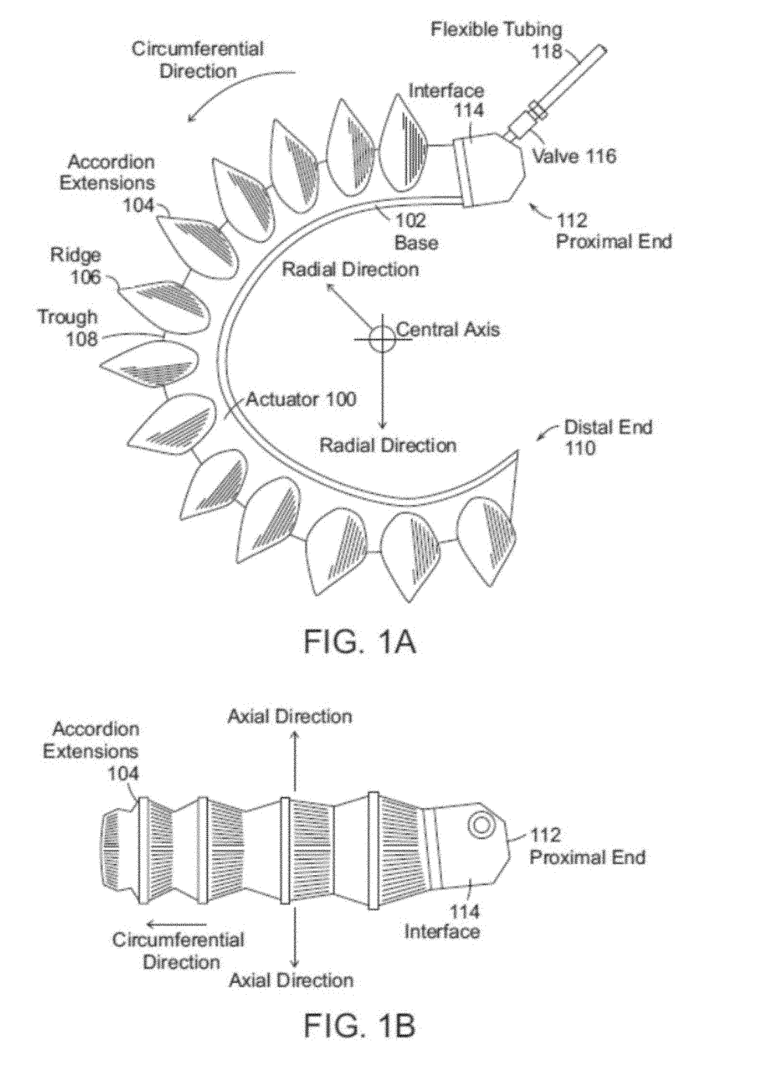

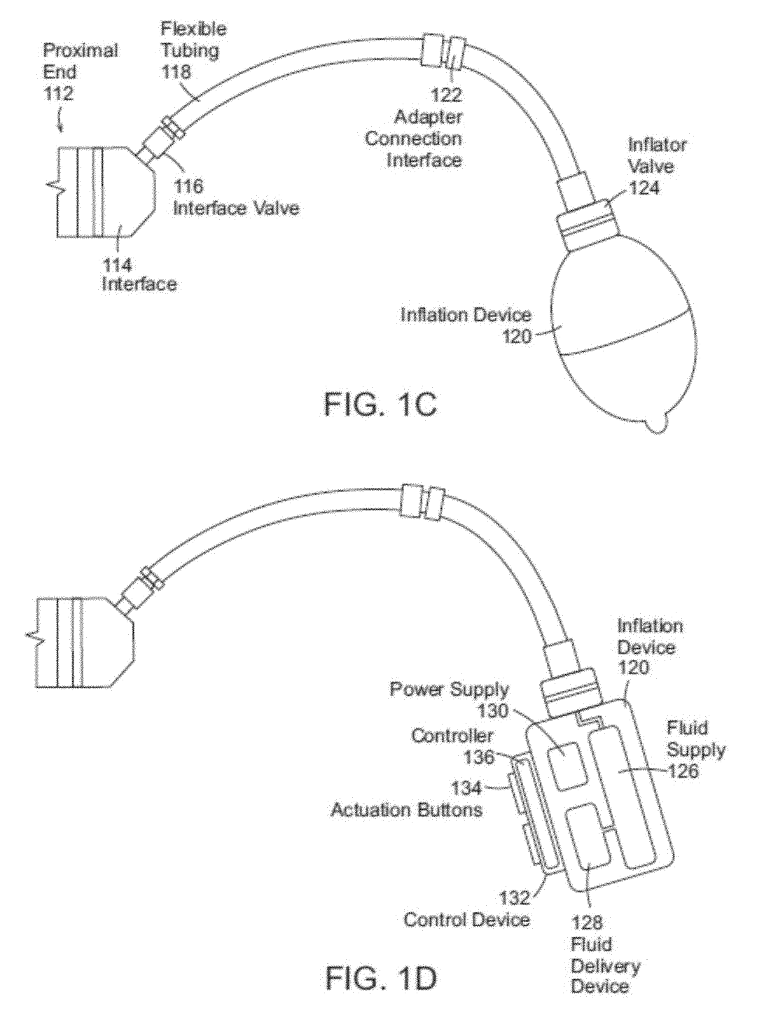

FIGS. 1A-1D depict exemplary soft robotic actuators. More specifically, FIG. 1A depicts a side view of a portion of a soft robotic actuator. FIG. 1B depicts the portion from FIG. 1A from the top. FIG. 1C depicts a side view of a portion of the soft robotic actuator including a pump that may be manipulated by a user. FIG. 1D depicts an alternative embodiment for the portion depicted in FIG. 1C.

An actuator may be a soft robotic actuator 100, as depicted in FIG. 1A, which is inflatable with an inflation fluid such as air, water, saline, or any suitable liquid, gas, gel, foam, etc. The inflation fluid may be provided via an inflation device 120 through a fluidic connection 118.

The actuator 100 may be in an uninflated state in which a limited amount of inflation fluid is present in the actuator 100 at substantially the same pressure as the ambient environment. The actuator 100 may also be in a fully inflated state in which a predetermined amount of inflation fluid is present in the actuator 100 (the predetermined amount corresponding to a predetermined maximum force to be applied by the actuator 100 or a predetermined maximum pressure applied by the inflation fluid on the actuator 100). The actuator 100 may also be in a full vacuum state, in which all fluid is removed from the actuator 100, or a partial vacuum state, in which some fluid is present in the actuator 100 but at a pressure that is less than the ambient pressure. Furthermore, the actuator 100 may be in a partially inflated state in which the actuator 100 contains less than the predetermined amount of inflation fluid that is present in the fully inflated state, but more than no (or very limited) inflation fluid.

In the inflated state, the actuator 100 may exhibit a tendency to curve around a central axis as shown in FIG. 1A. For ease of discussion, several directions are defined herein. An axial direction passes through the central axis around which the actuator 100 curves, as shown in FIG. 1B. A radial direction extends in a direction perpendicular to the axial direction, in the direction of the radius of the partial circle formed by the inflated actuator 100. A circumferential direction extends along a circumference of the inflated actuator 100.

In the inflated state, the actuator 100 may exert a force in the radial direction along the inner circumferential edge of the actuator 100. For example, the inner side of the distal tip of the actuator 100 exerts a force inward, toward the central axis, which may be leveraged to allow the actuator 100 to grasp an object (potentially in conjunction with one or more additional actuators 100). The soft robotic actuator 100 may remain relatively conformal when inflated, due to the materials used and the general construction of the actuator 100.

The actuator 100 may be made of one or more elastomeric materials that allow for a relatively soft or conformal construction. Depending on the application, the elastomeric materials may be selected from a group of food-safe, biocompatible, or medically safe, FDA-approved materials. The actuator 100 may be manufactured in a Good Manufacturing Process (“GMP”)-capable facility.

The actuator 100 may include a base 102 that is substantially flat (although various amendments or appendages may be added to the base 102 in order to improve the actuator's gripping and/or bending capabilities). The base 102 may form a gripping surface that grasps a target object.

The actuator 100 may include one or more accordion extensions 104. The accordion extensions 104 allow the actuator 100 to bend or flex when inflated or deflated, and help to define the shape of the actuator 100 when in an inflated or deflated state. The accordion extensions 104 include a series of ridges 106 and troughs 108. The size of the accordion extensions 104 and the placement of the ridges 106 and troughs 108 can be varied to obtain different shapes or extension profiles.

Although the exemplary actuator of FIGS. 1A-1D is depicted in a “C” or oval shape when deployed, one of ordinary skill in the art will recognize that the present invention is not so limited. By changing the shape of the body of the actuator 100, or the size, position, or configuration of the accordion extensions 104, different sizes, shapes, and configurations may be achieved. Moreover, varying the amount of inflation fluid provided to the actuator 100 allows the actuator 100 to take on one or more intermediate sizes or shapes between the un-inflated state and the inflated state. Thus, an individual actuator 100 can be scalable in size and shape by varying inflation amount, and an actuator can be further scalable in size and shape by replacing one actuator 100 with another actuator 100 having a different size, shape, or configuration.

The actuator 100 extends from a proximal end 112 to a distal end 110. The proximal end 112 connects to an interface 114. The interface 114 allows the actuator 100 to be releasably coupled to other parts. The interface 114 may be made of a food- or medically-safe material, such as polyethylene, polypropylene, polycarbonate, polyetheretherketone, acrylonitrile-butadiene-styrene (“ABS”), or acetal homopolymer. The interface 114 may be releasably coupled to one or both of the actuator 100 and the flexible tubing 118. The interface 114 may have a port for connecting to the actuator 100. Different interfaces 114 may have different sizes, numbers, or configurations of actuator ports, in order to accommodate larger or smaller actuators, different numbers of actuators, or actuators in different configurations.

The actuator 100 may be inflated with an inflation fluid supplied from an inflation device 120 through a fluidic connection such as flexible tubing 118. The interface 114 may include or may be attached to a valve 116 for allowing fluid to enter the actuator 100 but preventing the fluid from exiting the actuator (unless the valve is opened). The flexible tubing 118 may also or alternatively attach to an inflator valve 124 at the inflation device 120 for regulating the supply of inflation fluid at the location of the inflation device 120.

The flexible tubing 118 may also include an actuator connection interface 122 for releasably connecting to the interface 114 at one end and the inflation device 120 at the other end. By separating the two parts of the actuator connection interface 122, different inflation devices 120 may be connected to different interfaces 114 and/or actuators 100.

The inflation fluid may be, for example, air or saline. In the case of air, the inflation device 120 may include a hand-operated bulb or bellows for supplying ambient air. In the case of saline, the inflation device 120 may include a syringe or other appropriate fluid delivery system. Alternatively or in addition, the inflation device 120 may include a compressor or pump for supplying the inflation fluid.

The inflation device 120 may include a fluid supply 126 for supplying an inflation fluid. For example, the fluid supply 126 may be a reservoir for storing compressed air, liquefied or compressed carbon dioxide, liquefied or compressed nitrogen or saline, or may be a vent for supplying ambient air to the flexible tubing 118.

The inflation device 120 further includes a fluid delivery device 128, such as a pump or compressor, for supplying inflation fluid from the fluid supply 126 to the actuator 100 through the flexible tubing 118. The fluid delivery device 128 may be capable of supplying fluid to the actuator 100 or withdrawing the fluid from the actuator 100. The fluid delivery device 128 may be powered by electricity. To supply the electricity, the inflation device 120 may include a power supply 130, such as a battery or an interface to an electrical outlet.

The power supply 130 may also supply power to a control device 132. The control device 132 may allow a user to control the inflation or deflation of the actuator, e.g. through one or more actuation buttons 134 (or alternative devices, such as a switch, an interface, a touch display, etc.). The control device 132 may include a controller 136 for sending a control signal to the fluid delivery device 128 to cause the fluid delivery device 128 to supply inflation fluid to, or withdraw inflation fluid from, the actuator 100.

Soft robotic actuators may be useful in many instances where a hard actuator is undesirable. For example, and without limitation, a soft actuator may pick up a packaging blank or preform and provide it to a blow molder, after which the blow molder may reshape the blank into the desired form based on the mold. After being shaped, the molded part will typically be quite hot and deformable. The molded part may be retrieved by the soft actuator without damaging or deforming the molded part. The actuator may then hold the molded part while it is being washed, labeled, filled, and/or capped. Other soft actuators may hold live animals gently, such as for inoculation, analysis or surgery.

One problem in conventional blow molding operations is that the object being grasped has a different shape before and after blow molding (transitioning from the packaging blank to the finally-formed product. Whereas a hard gripper may have difficulty adapting to the changing shape (thus perhaps requiring two different types of grippers for a single blow molding operation, a soft actuator may be sufficiently adaptable to grasp both object shapes using the same gripper.

Soft robotic actuators may be inflated with a predetermined amount of inflation fluid (or to a predetermined pressure), and the inflow/outflow of the actuators and/or the internal pressure of the actuator may be measured. Upon making contact with an object, the actuator may be deflected and, as a result, inflation fluid may flow out of (or into) the actuator. This flow of inflation fluid may serve as a detector that indicates the presence of an object at a position or generally in contact with the actuator. Alternatively, the actuator may include touch sensors, bending sensors, or other types of detection devices for registering contact with an object.

FIGS. 1A-1D depict a particular type of soft robotic actuator, sometimes referred to as an accordion-type soft actuator. However, numerous other types of soft actuators exist, some of which are described in connection with particular embodiments below. Soft actuators include actuators formed partially or entirely from soft or compliant materials, and may incorporate or surround more conventional hard actuator materials.

Soft actuators may move in a variety of ways. For example, soft actuators may bend, as shown above, or may twist, as in the example of the soft tentacle actuator described in U.S. patent application Ser. No. 14/480,106, entitled “Flexible Robotic Actuators” and filed on Sep. 8, 2014. In another example, soft actuators may be linear actuators, as described in U.S. patent application Ser. No. 14/801,961, entitled “Soft Actuators and Soft Actuating Devices” and filed on Jul. 17, 2015. Still further, soft actuators may be formed of sheet materials, as in U.S. patent application Ser. No. 14/329,506, entitled “Flexible Robotic Actuators” and filed on Jul. 11, 2014. In yet another example, soft actuators may be made up of composites with embedded fiber structures to form complex shapes, as in U.S. patent application Ser. No. 14/467,758, entitled “Apparatus, System, and Method for Providing Fabric Elastomer Composites as Pneumatic Actuators” and filed on Aug. 25, 2014.

One of ordinary skill in the art will recognize that other configurations and designs of soft actuators are also possible and may be employed with exemplary embodiments described herein.

### End Effectors

An end effector may be the device at the end of a robotic arm, designed to interact with the environment, and/or may be the last link (or endpoint) of the robot. At an endpoint, tools may be attached; or, the end effector may itself act as a tool. An end effector may include one or both of a gripper or a tool. While grippers tend to hold, lift, transport and/or manipulate objects, tool functions often have a contrasting function, and may change a characteristic of the work object rather than gripping or holding it. Tool functions may include welding or fusing, spraying, dispensing, milling, screw or nut driving, flattening, cutting, and combinations of these.

At least four categories of end effector include impactive (e.g., jaws, claws, grasping a work object by direct impact, including holding friction); ingressive (e.g., penetrating the work object with needles, pins, or hackles); astrictive (e.g., essentially non-contact attractive or field forces such as Bernuilli lift, suction, magnetic, electrostatic, van der Waals', ultrasonic standing waves, laser tweezing), and contigutive (e.g., essentially contact adhesive forces via capillary action, glue, surface tension, freezing, chemical reaction).

In hard robotics, gripping may performed by using a form-following static shape in the gripping surface (e.g., a concave cup to lift a round object), or by friction force increased by closing hard fingers, jaws or claws. A soft robotic end effector may include gripper functionality, and may also or alternatively include some tool functionality. Soft robotic grippers may be impactive, and may additionally be made ingressive, astrictive, and/or contigutive via a particular gripper/actuation morphology or configuration, or by adding an accessory tool within or along or opposite the soft robotic gripper.

A soft robotic gripper may include one or more soft robotic members, which may take organic prehensile roles of finger, arm, tail, or trunk, depending on the length and actuation approach. In the case of inflating and/or deflating soft robotic members, two or more members may extend from a hub, and the hub may include a manifold for distributing fluid (gas or liquid) to the gripper members and/or a plenum for stabilizing fluid pressure to the manifold and/or gripper members. The members may be arranged like a hand, such that the soft robotic members act, when curled, as digits facing, a “palm” against which objects are held by the digits; and/or the members may also be arranged like an cephalopod, such that the soft robotic members act as arms surrounding an additional central hub actuator (suction, gripping, or the like). Generally, although not exclusively, as used herein, the terms “base plate”, “palm plate”, “bumper plate”, or “hub plate” may refer to a reference surface adjacent two or more soft robotic members against which the soft robotic member may hold a work object, e.g., when curled in a “closing” direction, and from which the grip of the soft robotic members on the work object may be released, e.g., when the soft robotic members are curled or recurled in an “opening” direction. The use of “plate” does not suggest that the member is fully planar—“plates”, unless otherwise described, may have surface relief, contour, curves, peaks and valleys, texture, or the like—a “plate”, unless otherwise described, describes a member fitting within a plate-like envelope or aspect ratio.

Soft robotic gripper members may be formed of elastomeric materials, such as rubber, and/or thin walls of plastic arranged in an accordion structure that is configured to unfold, stretch, and/or bend under pressure, or other suitable relatively soft materials. Soft robotic gripper members may include a channel and/or hollow interior that can be filled with a fluid, such as air, water, or saline to pressurize, inflate, and/or actuate the gripper member. Upon actuation, the shape or profile of the gripper member changes by, e.g., variably curving, curling, including in opposing directions, or straightening. Alternatively or in addition, the gripper member may be actuated using a vacuum to remove inflation fluid from the gripper member and thereby change the degree to which the gripper member bends, twists, and/or extends.

Actuation may also allow the gripper member(s) to exert a force on a workpiece, such as a workpiece being grasped or pushed, as well as partially or fully conforming to the shape of the workpiece being grasped. Soft robotic gripper members can also harmlessly deflect upon collision with workpieces or the work environment.

### Exemplary Meat Handling Grippers

Exemplary embodiments described herein relate to meat handling robotic grippers employing soft actuators, as described above.

As previously noted, previous robotic meat handling grippers suffered from several problems. Surface texture and malleability of the meat make it difficult to secure a strong grip. The planar shape of many meat products means that the products cannot be easily gripped from the side, but when suctioning the meat product along the top, meat tends to be sucked into the vacuum device. Meanwhile, the vacuum force may not be strong enough to secure a good grip on the meat product; if it is strong enough, it may leave a mark or impression on the product. Paper attached to the meat product must be identified and removed. And the meat may not be presented in an optimal orientation for grasping.

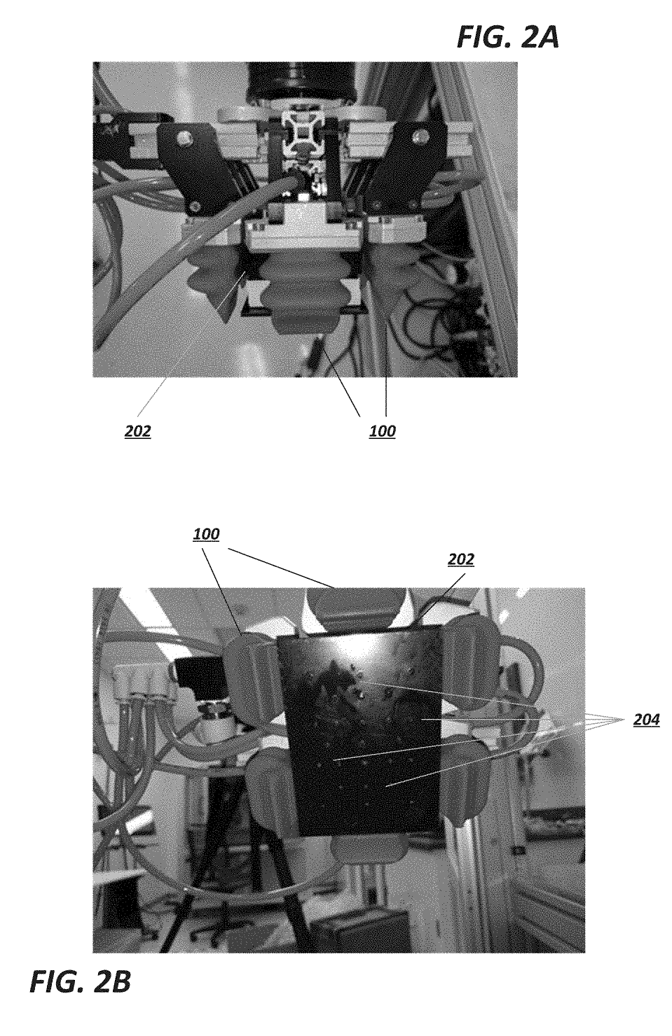

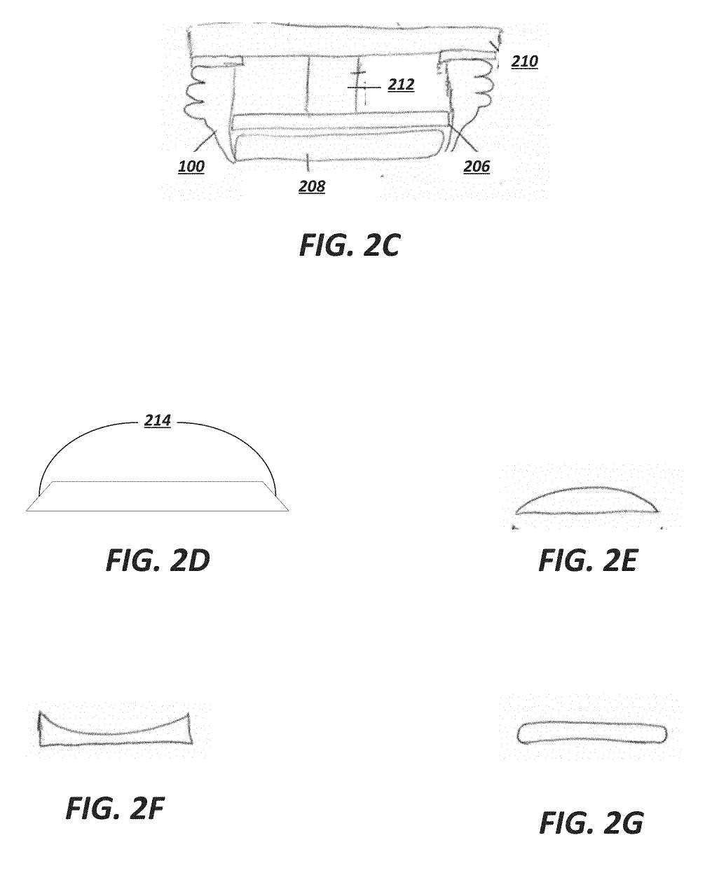

The present application provides examples of meat grippers that address these and other problems. For example, FIGS. 2A (side view) and 2B (bottom view) generally depict an exemplary meat gripper in accordance with the present disclosure.

As shown in these images, the gripper includes a planar pad 202 surrounded by a plurality of soft robotic actuators 100. The pad 202 includes holes 204 for applying a vacuum. When grasping a meat product, the pad 202 may be pressed into the product in order to make good, conformal contact with the product, and a vacuum may be applied to secure the product to the pad 202 along a top surface of the meat product. The actuators 100 may then be actuated to further grasp the product from the side, thereby securing a relatively strong grip so that the product can be moved, inspected, manipulated, etc.

Although the actuators 100 described and shown in these examples are mounted perpendicularly to the plane of the suction pad 202, it is noted the actuators 100 may be mounted at different angles with respect to the pad 202. For example, the actuators 100 may be angled inward towards the pad 202, thus allowing the actuators 100 to better grasp certain food products relative to the suction pad 202.

In these and other embodiments of the present invention, the vacuum pad 202 may act as a barrier or “hard stop” that prevents the surrounding fingers from curling forward. This constraint may, for example, prevent the fingers from deforming or reshaping the meat product. In other embodiments, the pad may force one or more of the fingers to bend or hinge around the plate, thus allowing the user to fine tune how the fingers grip the product.

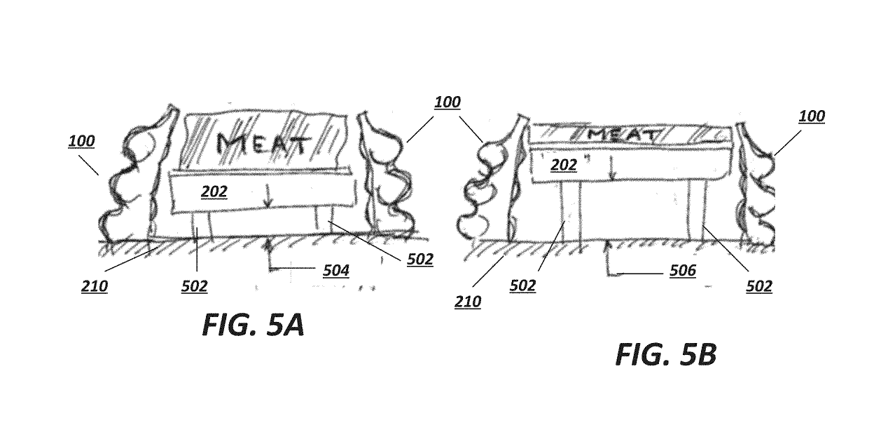

Another embodiment which does not employ a vacuum is depicted in FIG. 2C. As can be seen in this Figure, a bumper plate 206 is employed instead of a vacuum pad 202 to provide structure to grasp targets 20 that lack structure. The actuators 100 interact with the bumper plate, which provides structure for the actuators to grip the grasp target against. Furthermore, the bumper plate provides a physical stop for the actuators to aid in minimizing the grasp target deformation. It is possible to mount the bumper plate to a manifold 210 via one or more adjustable z-height post 212 to allow for varying grasp target heights, as shown in FIGS. 5A-5B. This post could also be made to be compliant, which allows for small range of grasp targets to be picked with the same gripper and bumper plate configuration.

The bumper plate 206 or the vacuum pad 202 can embody various geometries based on the application and grasp target, as illustrated in FIG. 2D-2G. For example, the chamfered edges 214 in the example depicted in FIG. 2D allow for a varied actuator interaction and less abrasion on the actuator from the bumper plate.

Various materials for the bumper plate 206 or vacuum pad 202 can be selected to suit the application or grasp target, including compliant materials and sanitary materials. The preferred materials for making the gripper hub are 303, 304, 316, & 316L stainless steel for metal parts and the plastic should be low porosity and does not swell more than 2% in moist environments. The preferred materials should be resistant to strong acids and strong bases as well as a high concentration of chloride ions. These chemical properties will allow the gripper hub to not be damaged by standard cleaning chemicals used in food production facilities.

In some embodiments, the vacuum pad 202 or bumper plate 206 may be an electro-adhesive pad.

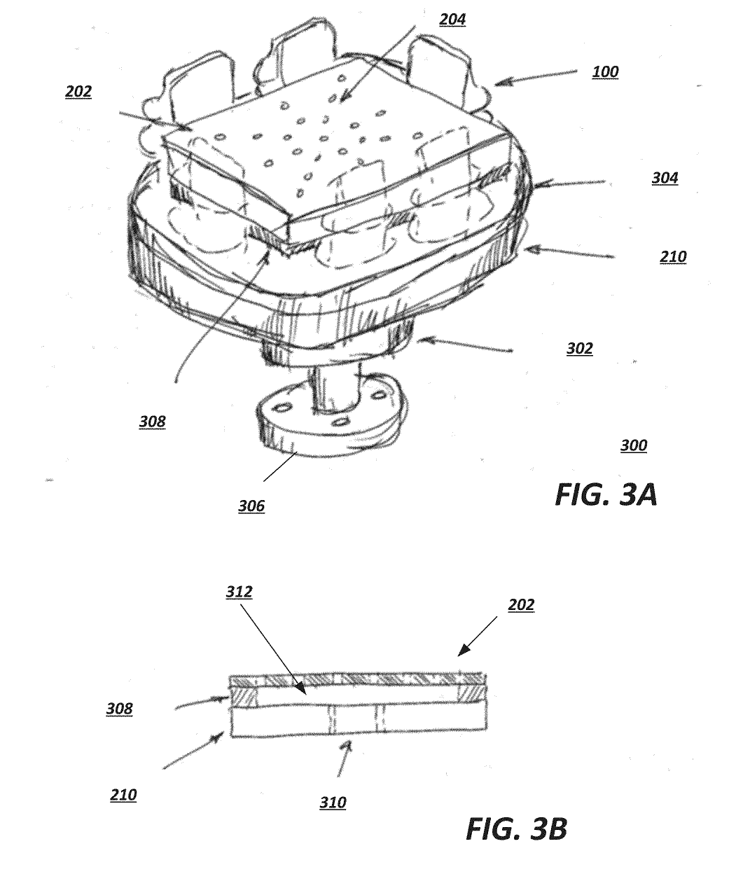

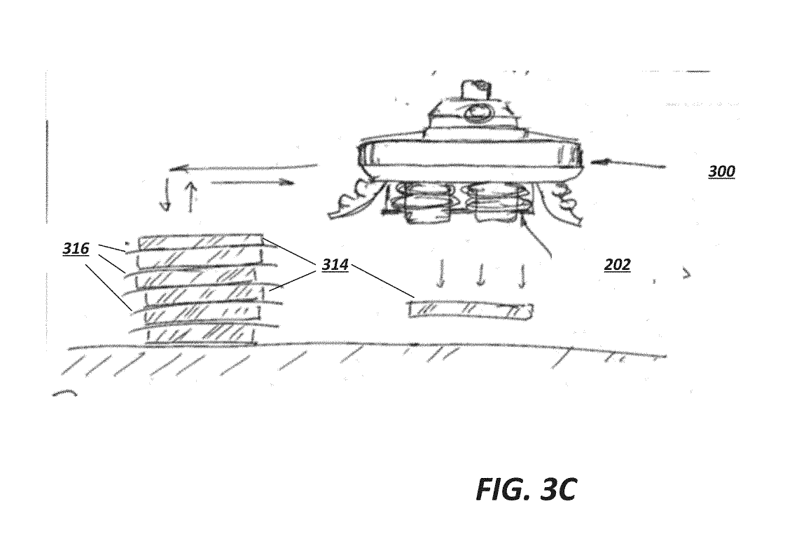

FIG. 3A provides an overview of a gripper mounted to a pedestal 302, together forming an end of arm tool (EOAT) 300; FIG. 3B depicts various features of the gripper from the side in a cross-sectional view.

The gripper may include the above-noted planar pad 202, which may be mounted to the manifold 210 via a pad suspension mount 308. The pad suspension mount 308 may serve to increase or decrease the distance from the top of the pad 202 to the gripping edges of the actuators 100, thus allowing for different sizes of meat products to be grasped. The pad suspension mount 308 may further one or more fluid flow channels 312, allowing vacuum pressure to be distributed to the holes 204 (or allowing fluid to be expelled from the holes 204). Still further, the pad suspension mount 308 may be formed of a material selected so as to be relatively compliant with respect to (e.g.) the planar pad 202 and/or the manifold 210. This feature allows for a certain amount of give when the pad 202 is pressed into contact with the meat product.

The fluid flow channels may be fluidically connected to the manifold 210. In some embodiments, the manifold 210 may have beveled edges 304 to allow for easy cleaning and to reduce bacterial harborage points.

The gripper may be mounted to a pedestal 302 that allows for quick mounting to a robotic arm or the like via a mounting bracket 306. The mounting bracket 306 may include a number of recesses for fasteners (e.g., screws or bolts) that mate to corresponding features on the robotic arm. The mounting bracket 306 may include a hollow opening in the center providing a flow path that allows a vacuum to be applied to the gripper. The opening may connect to a corresponding opening 310 in the manifold 210, which itself may connect to the flow field 312.

The flow path for the vacuum mechanism may alternatively be provided externally from the pedestal 302, such as through a fluid line connecting to the side of the manifold 210 or pad 202.

FIG. 3C depicts an overview of the EOAT 300 in operation. In particular, the EOAT 300 moves to a stack of meat patties 314 (left in FIG. 3C) and grabs the top patty 314. The EOAT 300 may be lowered with the assistance of a distance sensor to within a predetermined distance away from (or into contact with) the top patty 314 of the stack.

The pad 202 may be pushed into contact with the top patty 314 (or may be lowered to a close position, within a predetermined distance, of the top patty 314). When contact is made (or when the pad 202 is within the predetermined distance, or after the pad 202 exerts a predetermined amount of force on the patty 314), a vacuum may be applied to secure an initial grip on the patty 314. Once the vacuum is applied, the actuators 100 may be actuated to secure a grasp on the sides or bottom of the patty 314.

In other embodiments, the actuators 100 may first grasp the patty 314, thereby pushing the patty 314 into close contact with the pad 202. After the actuators 100 are inflated, vacuum may be applied by the pad 202.

In some embodiments, the air flow through the suction pad 202 can be used for grasp detection. If the air flow slows or stops (e.g., due to being blocked by the patty 314), this may serve as a trigger to indicate that the target object has been grasped. Actuation of the actuators 100 may be performed at that time, or this grasp detection may serve as a trigger to move the patty 314.

After securing a grasp on the patty 314, the EOAT 300 may raise away from the pile of patties 314. This maneuver may be made more complicated if, as is typically the case, different patties 314 in the stack are separated by a divider 316, such as wax paper. In some circumstances, the paper may stick to the bottom of the patty 314, but should be removed prior to delivering the patty 314 to its target location. In some cases, the paper will not adhere to the patty 314 being moved. Thus, the paper may need to be removed from the top and/or bottom of the patty 314. If the paper remains attached to the top of the patty 314 while the patty 314 is on the stack, then normally the paper should be removed before grasping the patty 314 with the EOAT 300. If paper is attached to the bottom of the patty 314 after the patty is grasped, then the paper should be removed at that point. Various techniques and mechanisms for removing a divider 316 from a patty 314 or other meat product are described below. It is contemplated that any one of, or a combination of, these techniques and mechanisms may be employed in connection with exemplary EOATs 300.

The EOAT 300 may move the grasped patty 314 to a target location (e.g., a conveyor belt, a food preparation or cooking surface, etc.). At this time, the EOAT 300 may release the patty 314 onto the target location. The actuators 100 may be de-actuated (e.g., the inflation fluid in the actuators 100 may be partially or completely evacuated), and the vacuum applied by the pad 202 may be deactivated. In some cases, the patty 314 may continue to stick to the pad 202 even after the vacuum is deactivated; in these cases, one or more release mechanisms/techniques may be employed. Such release mechanisms and techniques are described in more detail below. It is contemplated that any one of, or a combination of, these techniques and mechanisms may be employed in connection with exemplary EOATs 300.

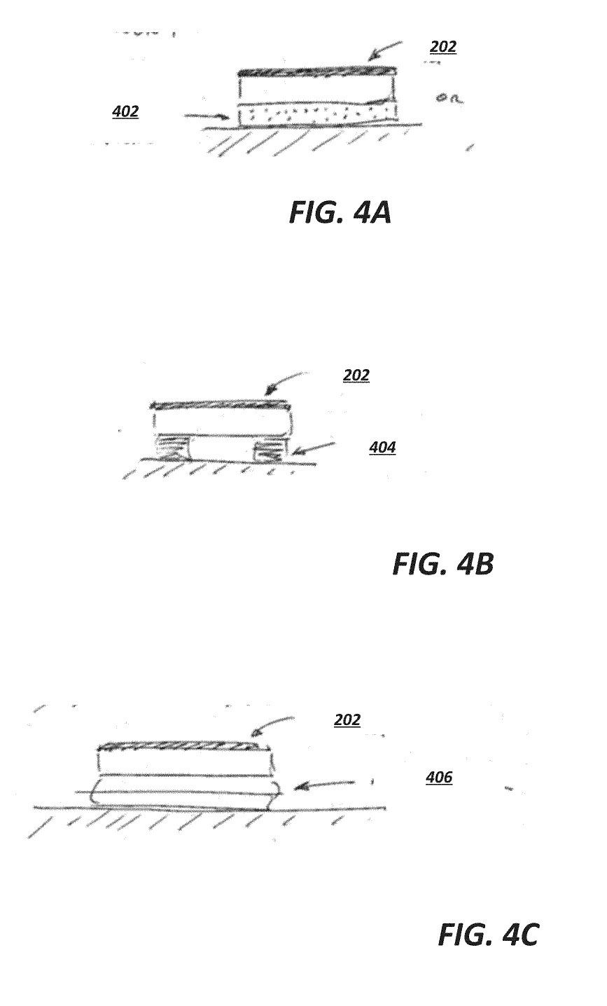

FIGS. 4A-4C depict examples of compliant mounts 308 suitable for use with exemplary vacuum pads. FIG. 4A depicts an exemplary compliant mount 402 constructed of closed-cell foam; FIG. 4B depicts an exemplary compliant mount 404 that includes one or more springs 404; and FIG. 4C depicts an exemplary compliant mount 404 made of an extensible bladder configured to be partially filled with a fluid, such as air or water.

FIGS. 5A-5B depict an example of an adjustable height vacuum pad whose height may be adjusted by controlling one or more adjustable z-height posts 502, suitable for use with exemplary embodiments.

The z-height posts 502 may include (for example) extension rods, bars, screws, etc. and may be configured to raise or lower the vacuum pad 202 with respect to the manifold 210; for example, FIG. 5A depicts the vacuum pad 202 at a first, relatively short distance 504 from the manifold 210 (indicated by the distance between the depicted arrows), whereas FIG. 5B depicts the vacuum pad 202 at a second, relatively large distance 506 from the manifold 210. This capability allows the target object (e.g., a meat patty or cut of meat) to be repositioned in the z-direction with respect to a grasping edge of the actuators 100. Particularly when, as shown in FIGS. 5A-5B, the target object is intended to be grasped from the sides, the capability to reposition the target object in the z-direction allows the gripper to secure a better grasp on the target object, particularly when successively grasping target objects of different sizes (as shown in the examples of FIGS. 5A, where the target object is relatively thick, and 5B, where the target object is relatively thin). Z-height adjustment may also be used to improve the gripper's capabilities in singulating target objects (e.g., removing a single target object from a stack), transport stability, and placement guidance.

This adjustment may be made by extending or retracting the z-height posts 502, for example by rotating threaded posts 502 by means of a motor, extending the posts 502 mechanically, electrically, pneumatically, hydraulically, or by other suitable mechanisms. The height of the z-height posts may be adjusted before, during, or after a vacuum is applied at the vacuum pad 202 and/or the actuators 100 are actuated.

The adjustable z-height posts 502 may include a fluid pathway for allowing a vacuum to be applied to the vacuum pad 202. Alternatively, the vacuum may be provided by other means, such as an external fluid path.

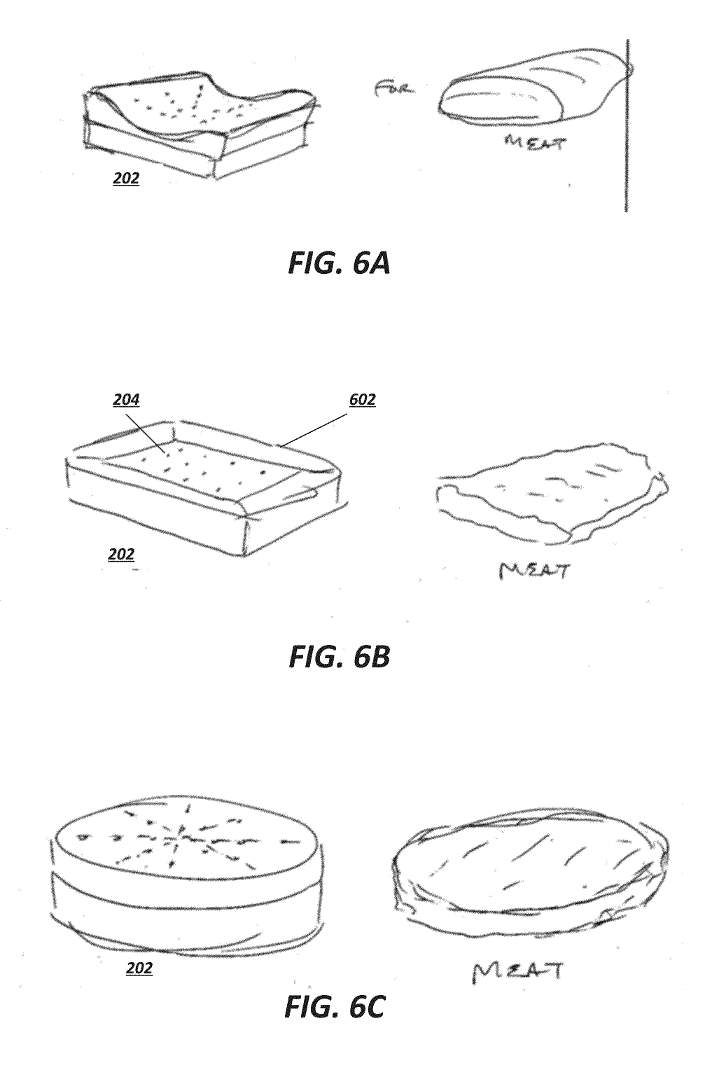

The top structure of the vacuum pad may be sized and shaped according to the particular application (e.g., the size and shape of the product to be grasped), as demonstrated in FIGS. 6A-6C. FIG. 6A depicts a concave vacuum pad 202 configured to receive a convex cut of meat. FIG. 6B depicts a vacuum pad 202 having a recessed portion in which the vacuum holes 204 are disposed; the exterior angled edges 602 allow the vacuum pad to better grasp cuts of heat having more variability in their surface features or textures. FIG. 6C depicts a vacuum pad 202 that is circular and flat, which may be well adapted to grasping meat patties. In addition to the shape of the vacuum pads 202, the size of the pads 202 and the configuration of the vacuum holes 204 may be varied depending on the application. The surface finish of the pads 202 also may be tailored to the particular product (e.g., type of meat) being gripped.

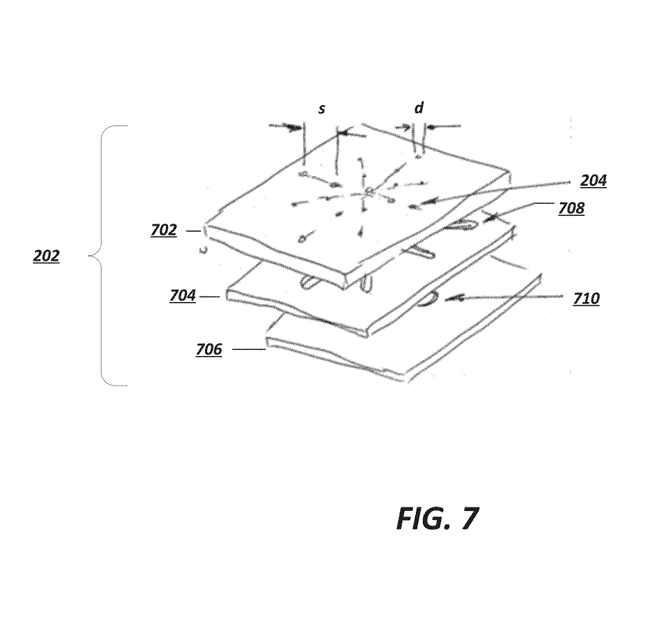

Preferably, the holes 204 in the vacuum pad 202 have a structure as shown in FIG. 7. In this example, the vacuum pad 202 is constructed of a top plate 702, a middle plate 704, and a bottom plate 706.

The holes 204 are formed in the top plate 702, where adjacent holes are separated by a distances of 10-20 mm (center-on-center), with a hole diameter d of 1.0-3.0 mm. These exemplary values provide good suction potential for securing the meat without allowing a substantial amount of meat product to be sucked into the vacuum ports.

The holes may be defined in a predefined pattern, such as a star pattern (depicted), a spiral pattern, a pattern of concentric circles, a rectangular or square pattern, etc., depending on the application. Preferably, the gripper has a suction pad with a sufficient number and configuration of suction holes to pick up the meat product when the suction holes are sized to prevent ground meat from being pulled up into the suction holes.

The middle plate 704 includes a flow field 708 such that, when positioned under the top plate 702, the flow field 708 is fluidically connected to each of the holes 204 in the top plate 702 and furthermore is fluidically connected to (and preferably centered on) a vacuum fitting hole 710 in the bottom plate 706. The vacuum fitting hole 710 may be fluidically connected to a vacuum generator for supplying a vacuum force to the holes 204.

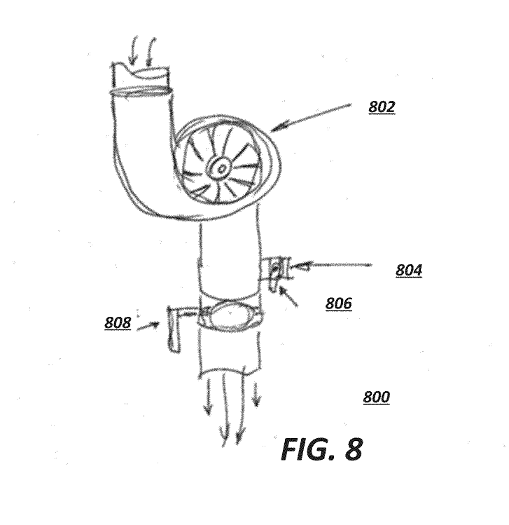

Even though some embodiments of the present invention are designed to minimize the likelihood that meat product is sucked into vacuum ports, this may be inevitable. Accordingly, it is desirable to utilize the above-described gripper in connection with a vacuum generator that can be easily cleaned. FIG. 8 depicts an example of such a vacuum pump 800.

There is no direct mechanical connection between the pump impeller 802 and the motor (internal, not shown) in the embodiment shown in FIG. 8. This may be achieved, for example, using a magnetically-coupled impeller 802. Consequently, any meat entering the pump 800 is prevented from causing damage to the pump 800 by stalling the motor.

Moreover, this embodiment is easy to clean because cleaning fluid can be passed through the pump 800 without damaging the motor, and the materials selected for the impeller 802 and fluid passages of the pump 800 may be selected based on their resistance to damage from cleaning agents, such as polypropylene or polytetrafluoroethylene.

Still further, a port 804 (openable via a valve 806) may be provided for injecting cleaning fluid into the pump 800. By closing a shut-off valve 808 located upstream of the port 804, the injected cleaning fluid is forced to flow towards the vacuum pad (towards the top of FIG. 8) to flush out any material that may be stuck in the vacuum pad holes.

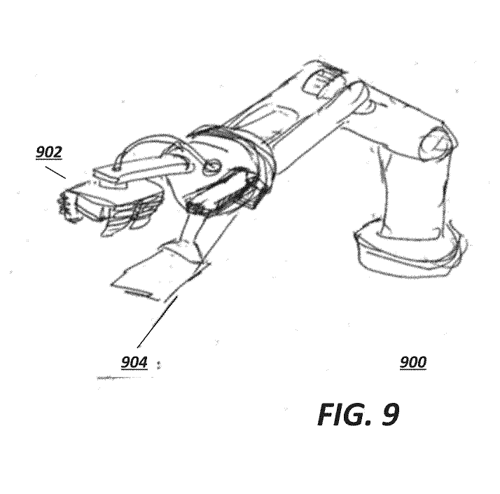

The exemplary gripper described above may be employed as a robotic end-of-arm tool (EOAT). An example of such a robotic arm 900 is depicted in FIG. 9. In this example, an exemplary gripper 902 may be provided at the end of the robotic arm 900 in conjunction with a robotic spatula 904, thereby allowing the robotic arm 900 to grasp meat from a stack, deliver the meat to a grill or oven, or a conveyor belt leading onto a grill or into an oven (potentially after the same or another robotic station removes paper from the meat), optionally flip the meat on the grill with the spatula 904, and deliver the cooked meat to a delivery location with the spatula 904.

In some embodiments, the robotic arm 900 may further include a temperature sensor, such as a meat thermometer or infrared sensor, to monitor the cooking of the meat and determine when it should be flipped.

In some embodiments, the EOAT may include an actuated pincer that can remove the paper from each patty. In other embodiments, the pincer is part of a nearby station where the robot presents the meat patty with paper to the machine to have the paper removed.

### Release Mechanisms

In some cases, it may be desirable to promote adhesion to the pad at the center of the gripper. In other situations, it may be advantageous to mitigate adhesion. For example, if the center pad is a suction device it may be preferable to choose a material for the pad to which the meat patty does not stick. Accordingly, once the suction is removed (e.g. when the system places the patty in a target location), the patty does not stick to the pad. This sticking can slow down operation of the system, because the system must pause while waiting for the patty to fall off the gripper. Furthermore, sticking may make the placement of the meat patty unpredictable, because the unsticking process will likely not happen the same way every time.

In cases where the patty is high in fat it may be advantageous to make the surface out of an oleophobic material to prevent adhesion. In cases where the patty has a high water content (or other polar material) it may be advantageous to make the pad out of a hydrophobic material to prevent adhesion. Still further, when the composition of the patty or its surface properties are changeable (or the gripper is being used for many different kinds of objects with different compositions), the pad may be made from an omniphobic material to prevent adhesion (e.g. PTFE). For reference, an “omniphobic” material refers to a material one that is both hydrophobic and oleophobic.

In the case where the center pad is not a suction pad (e.g., when the center pad is a simple plate) it may be useful to choose a material or surface chemistry that promotes adhesion. For example, if the patty is high in fat, it may be advantageous to make the surface out of an oleophilic material to promote adhesion.

In still other embodiments the center pad may surface treated to give it the desired surface chemistry to promote or mitigate adhesion (oleophobic, hydrophilic, or omniphobic).

Release may also be secured by active means. These mechanisms may allow the pad to be transformed from a stick- to a non-stick-surface on demand. For example, in some embodiments, air puffed back through the vacuum holes may assist with ejecting the meat from the vacuum pad.

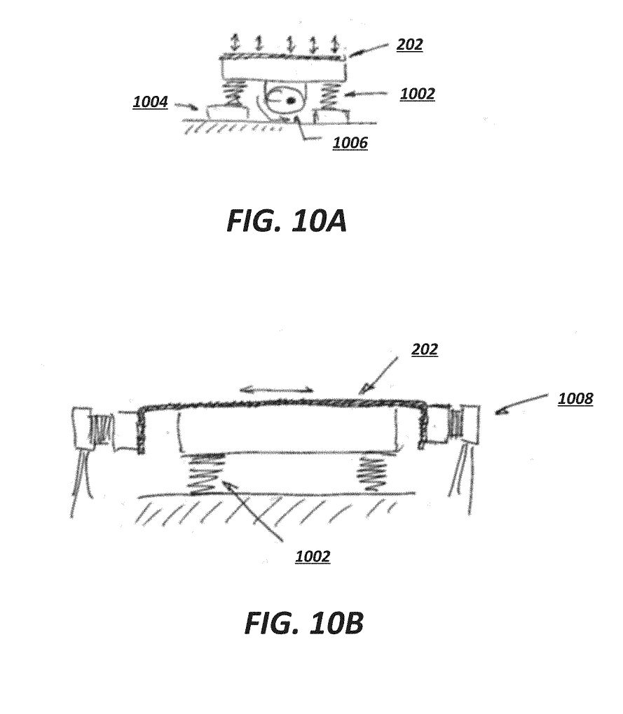

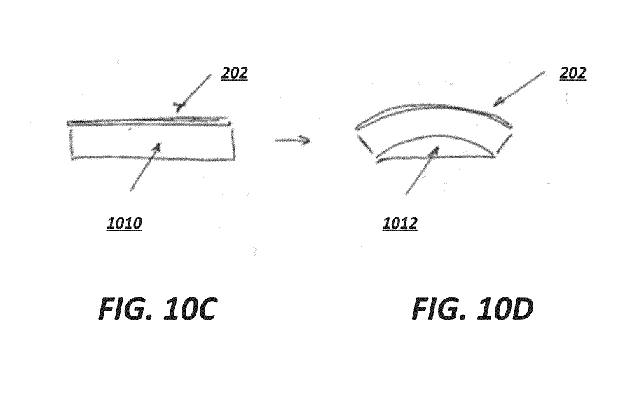

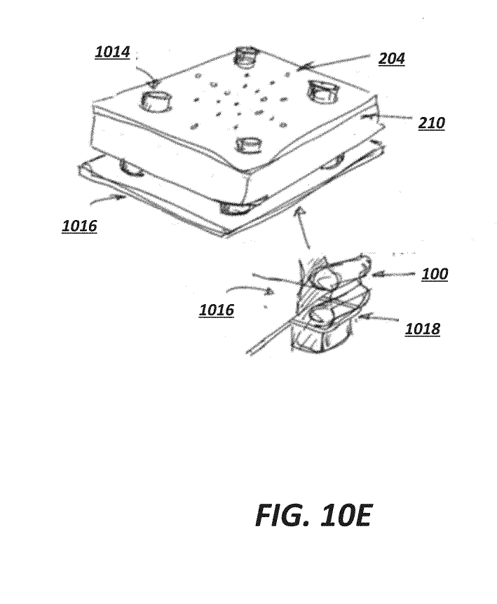

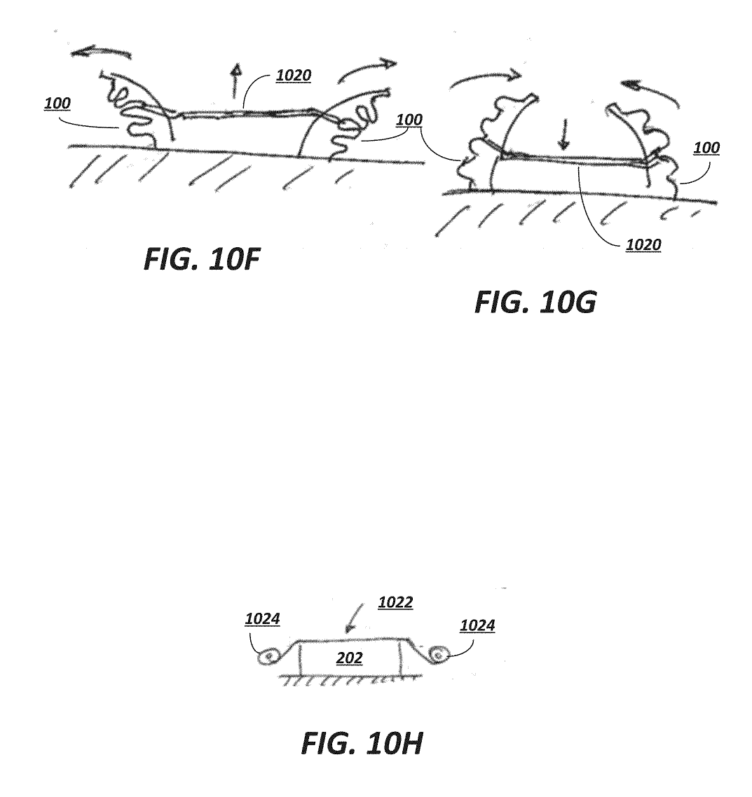

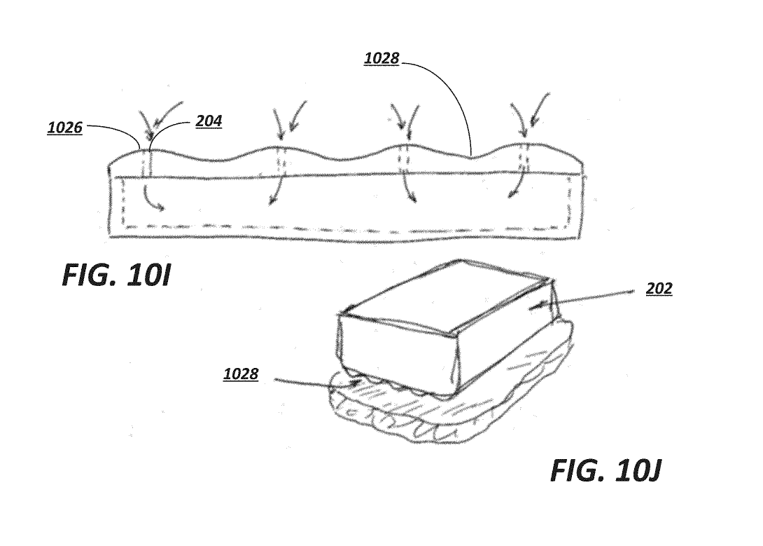

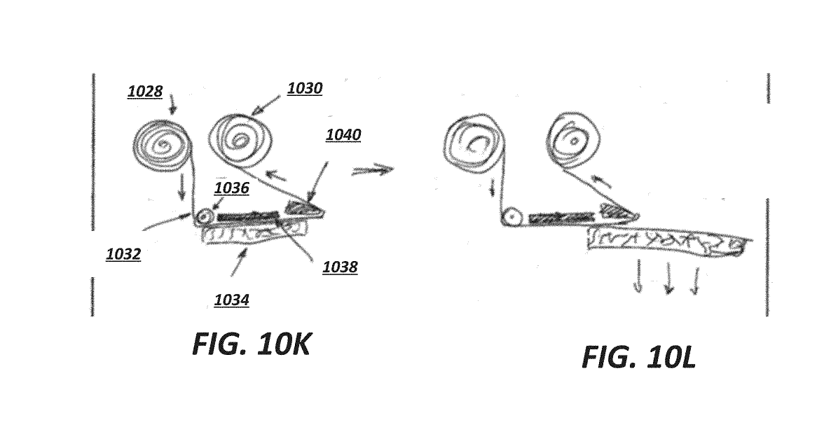

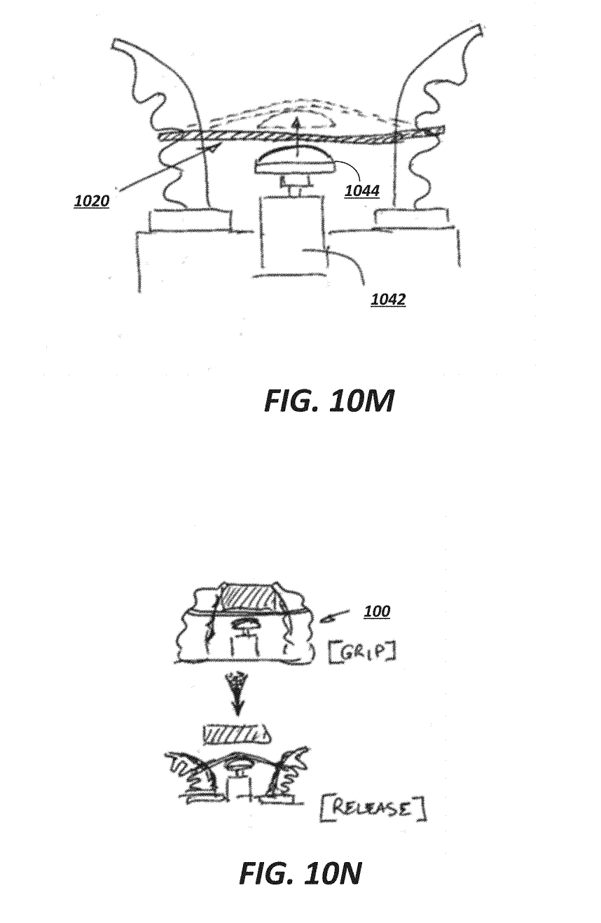

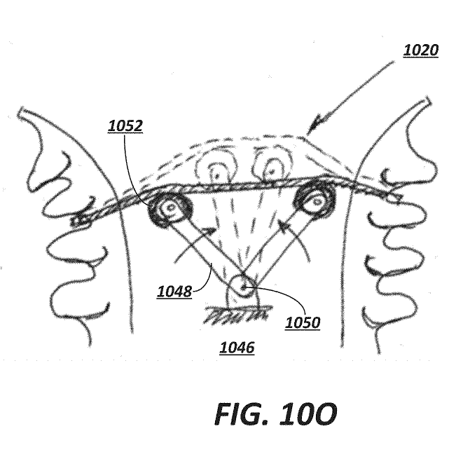

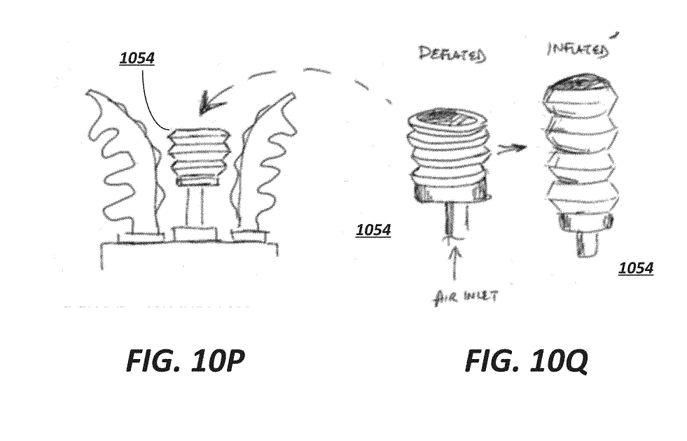

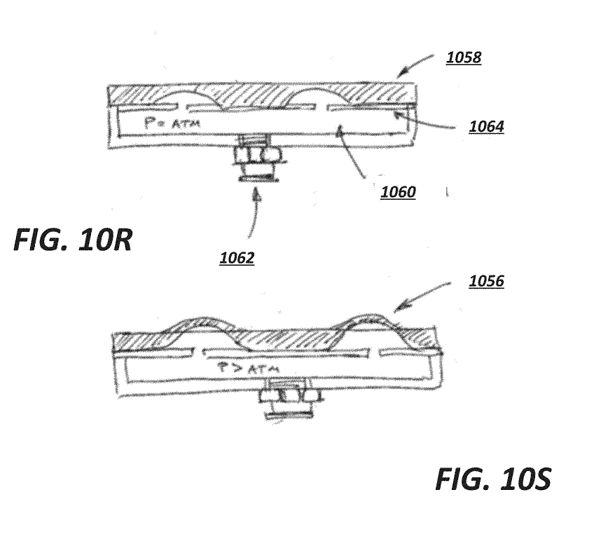

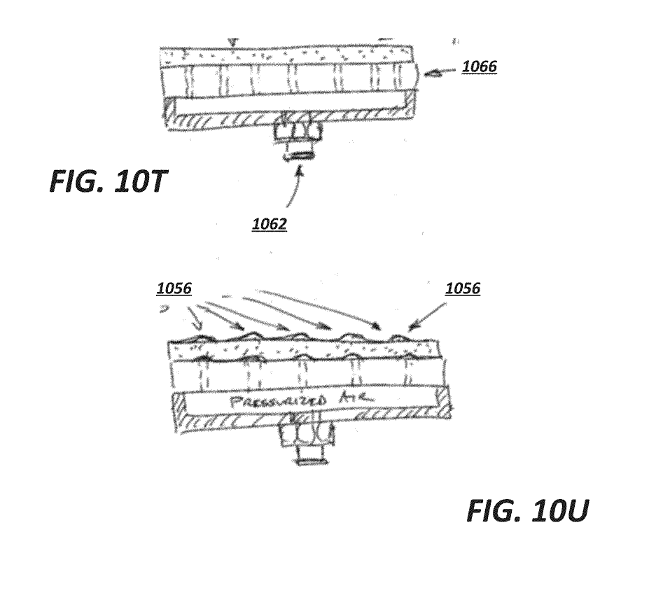

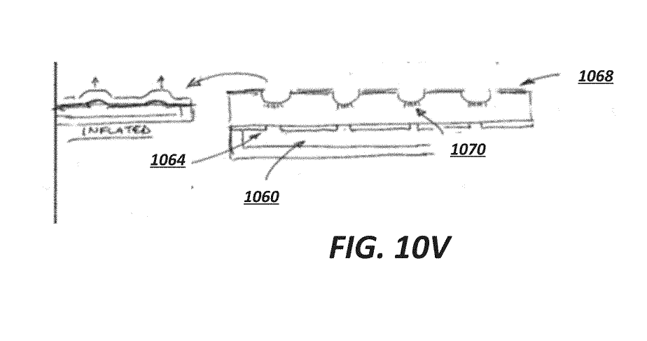

FIG. 10A depicts another example in which a vibratory release mechanism applies vibration to loosen or release the meat product. In this example, the vacuum pad 202 is mounted to one or more springs 1002 that are themselves mounted on isolators 1004 to isolate vibration to the pad 202. The pad 202 is also mounted to a vibratory motor 1006 with a rotating eccentric weight. By engaging the vibratory motor 1006, the pad 202 is made to vibrate, thereby encouraging the grasped object to work free from the pad 202.

FIG. 10B depicts an example of a pad 202 employing an ultrasonic actuator 1008 for releasing a meat product from the pad 202, according to exemplary embodiments. In this example, the pad 202 is again mounted to one or more springs 1002. The ultrasonic actuator 1008 may be configured to emit ultrasonic sounds waves in a predetermined or randomized pattern to cause the pad 202 to vibrate or otherwise move on the springs 1002, thereby encouraging the grasped object to work free from the pad 202.

FIGS. 10C-10D depict further examples of release mechanisms suitable for use with exemplary embodiments. In this example, the pad 202 sits on top of a rubber or otherwise deformable housing 1010, which in turn is disposed on top of an inflatable chamber 1012. The chamber 1012 may be inflated in order to deform the housing 1010. In some cases, the change in shape of the housing 1010 may be sufficient to cause the grasped object to be freed from the pad 202. In others, the inflatable chamber 1012 may be rapidly inflated in order to provide a more sudden popping effect, thereby forcing the grasped object free from the pad.

Release of a product may also or alternatively be accomplished using ejector bars or pins 1014, as shown in FIG. 10E. The ejector bars 1014 may be activated to move from a retracted configuration into an extended configuration (pictured) in order to mechanically push the grasped object away from the pad.

In some configurations, the ejector bars 1014 may be operable independently of the other components of the gripper. Alternatively, the ejector bars may be automatically activated and moved to the extended configuration through action of the actuators 100. In this configuration, the ejector bars 1014 may be attached to a stripper plate 1016 disposed under the manifold 210. A strap or band 1018 may be passed around one or more actuators 100 to attach the actuators 100 to the stripper plate 1016.

When the actuators 100 are actuated to grasp a target object, the actuators 100 move inwardly, thus pulling the stripper plate 1016 downwards, away from the manifold 210, and moving the ejector bars into the retracted position (thus allowing the pad 202 to secure the target object). When the actuators 100 are relaxed (or reverse-inflated) in order to release the target object, the actuators 100 move away from the pad 202 and therefore pull on the band 1018, which in turn pulls the stripper plate 1016 upwards, toward the manifold 210. Because the ejector bars 1014 are attached to the stripper plate 1016, the ejector bars 1014 are also pushed upwards, moving into the extended configuration.

A similar principle is used in the embodiments shown in FIGS. 10F-10G. In these embodiments, a rigid, elastomeric, or combination rigid-elastomeric structure 1020 is suspended between two or more actuators 100. The release structure 1020 is attached to the actuators 100, such that the target object is forcefully ejected when the fingers are relaxed or reverse-curled (e.g., with a negative inflation pressure).

In a preferred embodiment, the center of the release structure 1020 comprises a hard plate having a shape that approximates the shape of the food product to be handled. For example, if the food product is a ground beef patty, the release structure would include a circular hard section. In the same preferred embodiment, the outer sections of the release structure 1020, including parts that wrap around the accordion trough of the fingers, comprise an elastomeric material. The hard plate in the center of the release structure 1020 ensures that the ejection motion does not curl, warp or otherwise deform the food product.

The examples depicted in FIGS. 10F-10G may be used in embodiments in which no vacuum pad 202 is present. Alternatively, a stretchable vacuum membrane or rubber layer 1022 may be provided on top of the vacuum pad, as shown in FIG. 10H. The membrane 1022 may be perforated. In these embodiments, in order to release the target object, one or more rollers 1024 or stretching devices may be activated to increase tension on the membrane 1022. This stretches the membrane 1022, causing the force holding the target object to the membrane 1022 to be weakened or broken.

When the meat product is pulled away from the pad 202, it is possible that a vacuum will form between the meat and the pad's surface, which may inhibit or delay the release of the food product. This issue may be more likely for grasp targets that are moist, sticky, tacky, flexible and/or deformable. To alleviate this issue, the pad top 202 may be ridged so that the pad top makes contact only at the peaks 1024 of the ridges, as shown in FIGS. 10I-10J. The vacuum holes 204 may accordingly be located at the peaks (the arrows in FIG. 10I represent the direction of fluid flow when a vacuum is applied via the vacuum holes 204). Air may be run laterally across the surface of the pad, through the grooves 1026 between the peaks 1024, in order to facilitate release of the target object.

In some embodiments of such a pad structure, the grooves may include additional holes at the local minima (i.e., in the bottom of the grooves 1026). The holes may be connected to a different manifold layer as compared to the vacuum holes 204 in the local maxima of the pad, allowing air to be puffed through the holes in the grooves, thereby providing an air puff in a direction normal to the surface of the pad 202.

Release may also be secured by peeling the meat away from the gripper pad. To this end, a peeler bar and a one-time (e.g., wax paper) or multi-time use structure may be used, as shown in FIGS. 10K-10L. It is assumed, in these examples, that the target object 1034 is stuck to another object, such as a vacuum pad 202 or a stack of target objects 1034 (e.g., a stack of meat patties, potentially interspersed with dividers such as wax paper) towards the bottom of the Figures.

In this example, the wax paper or other structure 1032 is supplied at a supply roll 1028 and retrieved at a take-up roll 1030. The structure 1032 is passed over an idler 1036 (e.g., a roller) and then is passed across a support plate 1038 before being passed over a peeler bar 1040. The support plate 1038 is pressed into the free end of the target object 1034 (i.e., the end that is not stuck to the other object), with the structure 1032 interposed between the support plate 1038 and the target object 1034. The target object 1034 thereby adheres to the structure 1032.

Subsequently, one or more of the supply roll 1028, the take-up roll 1030, the idler 1036, or another rolling device is activated to rapidly advance the structure 1032 towards the take-up roll 1030 (see FIG. 10L). This rapid advancement breaks the target object 1034 from the other objects to which it is stuck, and also serves to shed the target object 1034 from the structure 1032 as the structure 1032 passes over the peeler bar 1040.

These embodiments may optionally be used in conjunction with one or more actuators 100 to assist in freeing the target object 1034 from the other object to which it is stuck (e.g., by securing the other object so that the target object 1034 and the other object do not advance together when the structure 1032 is moved).

Still further release structures are shown in FIGS. 10M-10V. Many of these embodiments address the possibility of a vacuum forming between the meat product (or other grasp target) and the pad, as previously described.

For example, the embodiment shown in FIGS. 10M-10N is similar to that depicted in FIGS. 10F-10G, but with the addition of an electric, pneumatic, hydraulic, etc. actuator 1042 having a head 1044 disposed under the structure 1020. The head 1044 of the actuator 1042 peels the structure 1020 away from the target object while simultaneously applying a force on the structure 1020 for ejection of the target object from the gripper.

In the case of a circular meat product or other grasp target, the actuator head 1044 is preferably a centrosymmetric domed structure. Such a shape will peel the structure 1020 away from the circular grasp target starting at its outside edges and moving inward. In the case of a rectangular grasp target, the actuator head 1044 is preferably the shape of a half-cylinder, which could be used to peel the structure 1020 away from the grasp target starting at its edges and moving inward.

The embodiment shown in FIG. 100 may be particularly well suited for rectangular grasp targets. In this example, the structure 1020 is bumped up by a mechanism 1046 configured to raise the center of the structure 1020. One example of such a mechanism 1046 may include one or more bars 1048 rotatably connected to a hinge 1050, with a roller 1052 attached to the opposite ends of the bars 1048.

FIGS. 10P-10Q depict a center-mounted pneumatic actuator 1054, which includes a flat top for contact with a target object when deflated, and a domed top when the actuator 1054 is inflated; inflation may also cause the actuator 1054 to extend, thereby pushing the target object away from the gripper.

Other embodiments, such as shown in FIGS. 10R-10U, make use of raised portions or bumps 1056 that are actuated to dislodge grasp targets that are likely to adhere to the pad. In the example of FIGS. 10R-10S, thin spots in a rubber or elastomeric layer 1058 are raised to form the bumps when a plenum 1060 is filled with air via an air fitting 1062, admitting air into the area near the elastomeric layer 1058 through a perforated support plate 1064. Alternatively, instead of a support plate, a manifold 1066 having holes may be provided, as shown in FIGS. 10T-10U.

The same principle can be used to selectively expose different regions 1068, 1070 to a target object, where the different regions 1068, 1070 have different compositions or properties. For example, in the embodiment depicted in FIG. 10V, region 1068 comprises a material that is more hydrophobic than region 1070. When the bumps are not raised, the region 1070 is exposed, which is relatively hydrophilic. This allows a target object, such as meat, to adhere to the gripper. When it comes time to release the target object, the bumps are raised as described above and the relatively hydrophobic region 1068 is exposed to the target object (see inset at left of FIG. 10V).

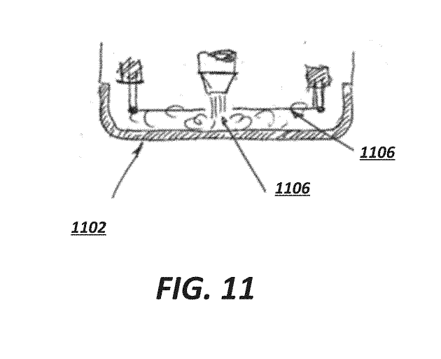

Adhesion control may also be accomplished using temperature. FIG. 11 depicts an example of controlling adhesion by heating or cooling the interface 1102 between the meat and the gripper's pad. When the interface 1102 is heated (e.g., via a heater wire 1104), the fat present on the meat may liquefy, thereby allowing the meat to be released. When the interface is cooled (e.g., by an air blast from an air outlet 1106), the meat fat may congeal, thereby forming a sort of adhesive that secures the meat to the gripper pad.

Advantageously, the interface 1102 of the gripper pad may be maintained close to a temperature at which the fat congeals. Accordingly, by adjusting the temperature of the pad by only a small amount, the properties of the meat may be altered as described above in a rapid fashion.

It is contemplated that any of the above-described release mechanisms may be used, singly or in combination, with the grippers described herein. The release mechanisms may include fluid pathways formed in suitable locations to allow the vacuum force to be delivered to the holes 204 of the vacuum pad 202.

### Fixturing Station

To improve the speed and the reliability of the above-described system, it may be helpful to present the target object to the robot in a consistent location. This may include reproducing the X, Y, and Z location of the object as well as the rotation of the object about the Z-axis in situations where the object is not circular (e.g. a square burger patty).

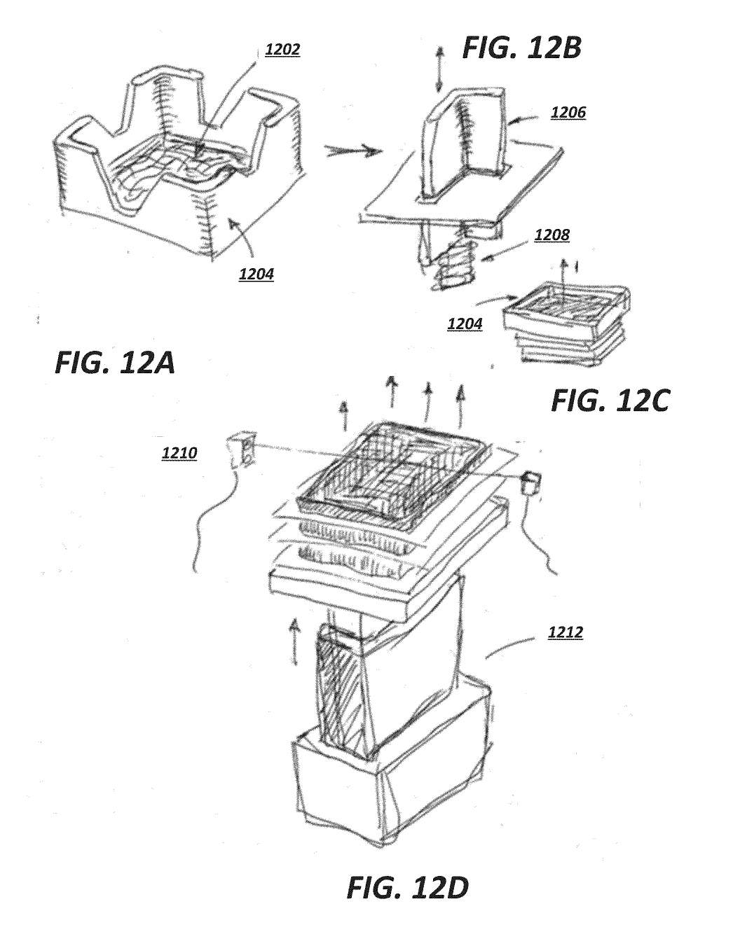

In one embodiment, a stack of paper-separated ground meat patties 1202 (or other target objects) can be placed on a plate capable of being elevated such that every time a meat patty 1202 is removed from the top of the stack by the robot, the remaining stack of patties is elevated so the patty at the top of the stack is at the correct pick height to be picked up by the robot. An example of such an object presentation station is depicted in FIGS. 12A-12D.

In some embodiments, the fixturing station 1204 will have guide rails 1206 surrounding the stack to prevent the stack from translating in the X or Y direction due to mechanical interactions with the robot that can occur during gripping. The stack may rest on a plate that is elevated by one or more springs 1208, allowing the plate (and, hence, the stack) to be elevated to a predetermined picking height automatically. Alternatively or in addition, the stack may be located on top of an actuator 1212 guided by a trip beam from a light emitter 1210. When the trip beam is not broken (i.e., no target object 1202 is in the way of the trip beam), the actuator 1212 may be activated to move the stack upwards until the beam is broken. In this way, the stack may always be presented at the height of the trip beam.

In still other embodiments the meat patty fixturing station has the capacity to tilt the stack of meat to control the orientation of the top surface of the patty at the top of the stack. The control over orientation will improve the robot's capacity to remove patties from the stack.

### Actuator Structure

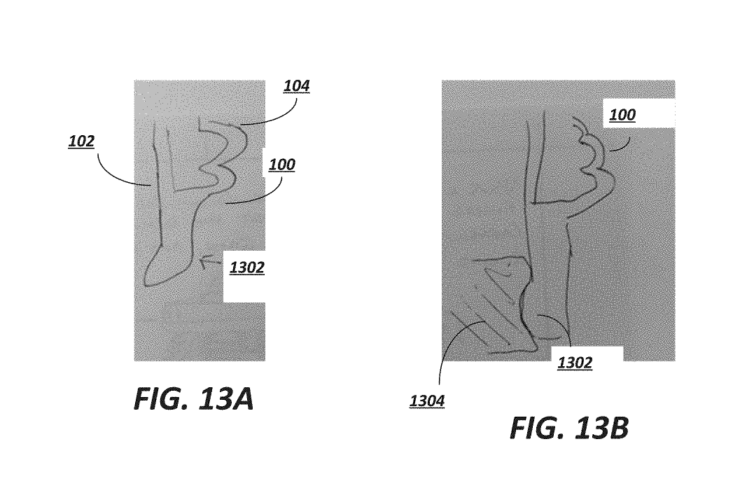

In some embodiments, the actuators 100 may include flipper tips 1302 that are hooked at their distal ends to help them pull individual target objects off a stack of target objects, as shown in FIG. 13A. The flipper tips 1302 may protrude from the base 102 of the actuator in a direction opposite that of the accordion extensions 104. In further embodiments, the actuator 100 may include a bump or ridge that pushes into the side of the target object 1304, thereby preventing the meat from sliding out of the actuator grip, as shown in FIG. 13B.

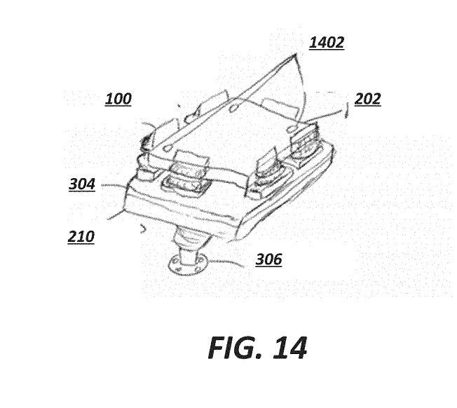

In some embodiments, other types of sensors in addition to those previously described are used. For example, 3-point lidar proximity sensors 1402 can be integrated into the gripper bumper plate or other suitable locations on the gripper palm to define the plane of the grasp target as shown in FIG. 14. Alternative sensors could be employed to sense the proximities at the 3-points, such as structured light sensors, structured light cameras, time of flight sensors, stereo visible light cameras, stereo infrared light cameras, RGBD cameras, etc. This integration allows the gripper to automatically determine the best approach of the star/bumper plate to achieve the best grasp target adhesion/interaction. In yet another embodiment the sensor system could be integrated in to a meat patty fixture station as opposed to being in the gripper itself.

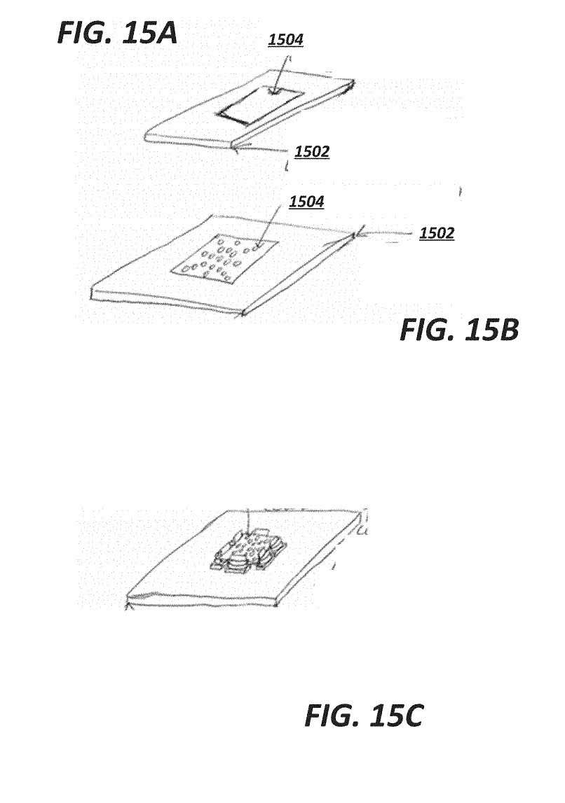

In some embodiments, grasp targets are actively located in a stack by using a retention table 1502 as illustrated in FIG. 15A. The target object can be held in place by controlling the temperature of the pick location 1504, such that the location temperature is chilled so that the grasp target will adhere to the surface and heated to lessen the grasp target adhesion (as discussed above in connection with FIG. 11). The pick location 1504 could also or alternatively employ a stationary star plate 156 integrated into the table 1502, as shown in FIG. 15B. This would allow suction to actively retain the grasp targets. An integrated gripper with star/bumper/temperature-controlled plate (FIG. 15C) could also be employed to actively locate the grasp target in a stack.

In still other embodiments the meat patty fixturing station has the capacity to tilt the stack of meat to control the orientation of the top surface of the patty at the top of the stack. The control over orientation will improve the robot's capacity to remove patties from the stack.

### Grasping Method

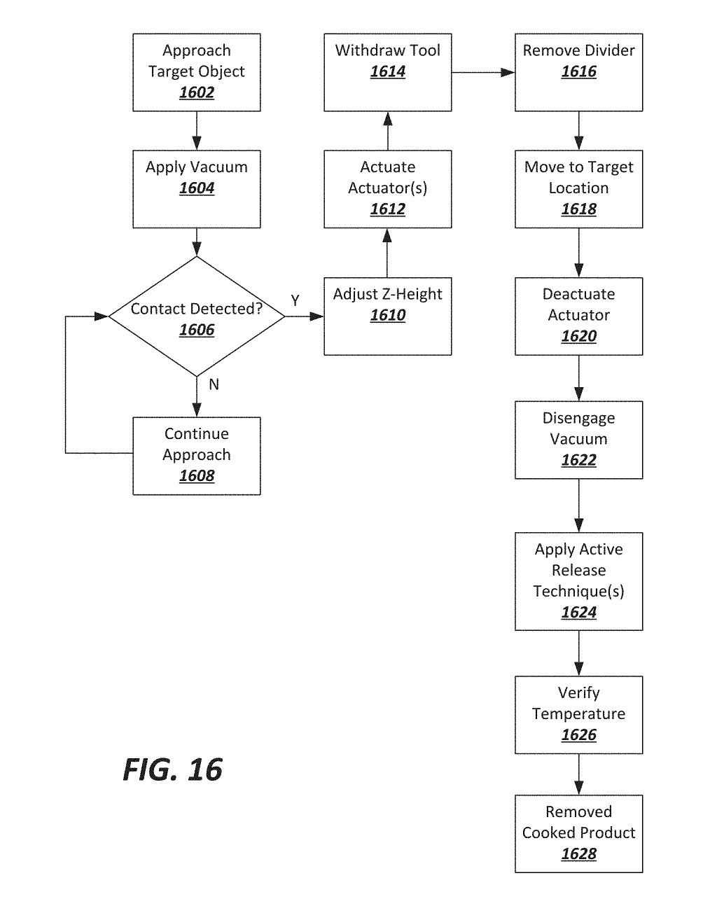

FIG. 16 is a flowchart describing an exemplary grasping technique in accordance with exemplary embodiments.

At block 1602, a robotic system may approach a target object at an initial location with a robotic end-of-arm tool, such as any of the above-described tools. The system may detect the presence and/or location of the target object using one or more proximity sensors, such as RADAR, LIDAR, IR proximity detection, etc. The target object may be initially located at a fixturing station (see, e.g., FIGS. 12A-12D) configured to present the target object at a consistent location. The target object may be a meat product.

At block 1604, the system may apply a vacuum before, during, or after the approach of the target object. The vacuum may be applied by activating a vacuum generator, such as the one depicted in FIG. 8. As a result of applying the vacuum, a vacuum force may be applied at the holes of the vacuum pad on the end-of-arm tool.

At block 1606, the system may determine whether the tool has made contact with the target object. In some embodiments, the system may detect a reduction or stoppage of air flow through the holes in the vacuum pad, which may indicate that the vacuum pad has made contact with the target object. This change in air flow may also be associated with a change in pressure, which may also be detected. In some embodiments where the system includes a complaint pad mounted under the vacuum pad, contact with the target object may be determined by detecting a change in the compliant pad (e.g., a compression of springs or a fluid bladder). In still other embodiments, the vacuum pad may be provided with a simple contact sensor (e.g., a bumper) to determine when the system has physically made contact with the target object.

If the determination at block 1606 is “no,” i.e., contact has not been detected, then processing may proceed to block 1608 and the system may continue its approach to the target object until contact is detected. On the other hand, if contact is detected at block 1606 (a “yes” determination), then processing may proceed to block 1610.

At block 1610, the system may optionally activate one or more z-height adjustment posts to vary the position of the target object (now secured to the vacuum pad) with respect to one or more grasping surfaces of the actuators. In some embodiments, the system may apply one or more sensors to detect a size of the target object and vary the z-height accordingly.

At block 1612, the system may actuate one or more actuators to grasp the target object. Actuating the actuators may involve opening one or more valves, operating a compressor, etc. in order to provide inflation fluid to the actuators. The actuators may be actuated to a predetermined inflation pressure, or may be actuated to a dynamically-determined pressure based on one or more sensor readings and/or an estimated grasp strength. In some embodiments, the amount of actuation fluid supplied is dependent on the target object being grasped, and is configured to secure a reasonable grasp (e.g., within a predetermined range of grasping forces) without applying sufficient pressure in a given area to deform or otherwise damage the target object.

At block 1614, the system may withdraw the tool to remove the target object from the target location. This may involve separating the target object from a stack of objects. In some embodiments, the target object may be separated from other objects in the stack by a divider, such as wax paper. In block 1616, the system may determine whether the divider remains attached to the target object (e.g., using one or more sensors), and, if present, may remove the divider using a pincer or other removal device (see, e.g., FIGS. 10K-10L).

Similarly, if a divider remains on the top of the next target object in the stack, then the system may optionally set a flag indicating that, on the next approach of the target object (1602), the system should activate the pincer or other removal device to remove the divider from the top of the next target object, before securing the target object to the vacuum pad.

In some cases, the system may take a blind approach to divider removal, and may simply assume that paper is attached to the top and/or bottom of the target object without verifying that this is the case. In these embodiments, a pincer or other device may attempt to grasp at a location at which paper would otherwise be present (on top of the stack of products in the case of a divider on top of the target object, and on the bottom of a grasped target object in the case of a divider on the bottom of the target object). If the divider is present, the device will remove the divider. If the divider is not present, the device can still go through the motions of removing a divider without actually grasping any dividers.

In some embodiments, a fixturing station presenting the target objects for grasping may be configured to remove the divider (e.g., the fixturing station may include one or more clamps, actuators, etc. configured to hold the dividers in place while the target object is removed, thus obviating the need for the end-of-arm tool to remove the dividers from the retrieved target object).

At block 1618, the system may move the target object to a target location. The target location may be a predefined location, such as a conveyor belt, a location for packaging, or a cooking surface. The target location may be non-predefined location, or may be dynamically selected from a number of possible predefined locations based on the context (e.g., different types of target objects may be detected and moved to different locations; objects may be alternately placed at different packaging stations or on different cooking surfaces, etc.). Optionally, the system may locate the target object in a particular position and/orientation at the target location—such as by sensing other nearby objects on a cooking service or in a package and placing the target object so as not to interfere with other nearby objects.

At blocks 1620-1624, the target object may be released at the target location. Releasing may involve deactuating the actuator at block 1620 (e.g., by evacuating some or all of the inflation fluid from the actuator), fully or partially disengaging the vacuum at block 1622, and optionally applying one or more active release techniques at block 1624. These active release techniques may involve, for example, vibrating the target object, applying heat or cold to the target object or vacuum pad, using a mechanical release device such as pins, ejector bars, an inflatable bladder, selectively raiseable ridges, elastic sheets, etc., puffing air through the holes in the vacuum pad, and other techniques. Some non-limiting examples of active release techniques are demonstrated in connection with FIGS. 10A-11.

In some embodiments, processing may terminate after the release procedure. In others (e.g., where the target object is meat and the target location is a cooking surface), the system may proceed to block 1626, where the system monitors the temperature of the target object. The system may apply one or more sensors, such as a meat thermometer or infrared sensor, to determine a temperature of the target object. When the target object's temperature has been raised above a predefined threshold, processing may proceed to block 1628 and the system may remove the cooked product (e.g., using a spatula tool as shown in FIG. 9).

In some embodiments, the system may consult a second predefined threshold higher than the above-described threshold, where the second predefined threshold is consistent with over-cooking of the target object. If the temperature of the target object is raised too high, the system may discard the target object. The system may further check the target object using other sensors (such as a camera to detect char marks, a smoke detector to detect burning, etc.) to verify whether the target object should be discarded.

Assuming that the target object is not discarded, the cooked target object may be delivered (e.g., by the spatula tool) to another target location to be served.

The above-described method may be embodied as instructions or logic stored on a non-transitory computer-readable medium. When executed, the instructions or logic may cause a processor circuit to perform the above-described method using a robotic system.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

In the foregoing description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Any or all of the above-described techniques may be implemented by suitable hardware, including pneumatic, hydraulic, mechanical, electrical, magnetic, etc. hardware. Some embodiments may utilize logic stored on a non-transitory computer-readable medium. When executed by one or more processors, the logic may cause the processors to perform the techniques identified above. The logic may be implemented fully or partially in hardware. The logic may be included as part of a controller for controlling the actuation, de-actuation, movement, position, etc. of a soft robotic actuator and/or a soft robotic system employing one or more actuators in a gripper arrangement.

As used herein, structures, acts, steps, and functions are given various names or labels. This paragraph describes terminology that is used alternatively, in some cases interchangeably, and in some cases equivalently. Generally, one of skill in the art will recognize and understand identity, equivalency, and the similarities and differences among alternative terms of art and/or words having a plain technical meaning. As used herein, an end effector may include an effector including a tool or one to which a tool may be mounted, including EOAT 300 and the like. An organic article may be a meat article or meat product, such as (non-exhaustively) meat patty 314 or an organic article having similar properties (e.g., soy-based equivalent). Bendable members may include soft robotic members such as soft robotic actuators 100. An ejection mechanism or ejection force may forcibly eject an article, but need not forcibly eject an article, but may release it to fall under the effect of gravity - e.g., an ejection force may be largely gravity, applied by releasing the article. A palm plate may include a portion of a gripper assembly including a surface against which articles may be pressed, such as planar or vacuum pad 202 or bumper plate 206. A perforated air table may include a surface with a plurality of holes for permitting fluid flow through the holes, often air flow, such as suction pad 202. A spatula member may be stationary with respect to a supporting drive system or articulated, such as robotic spatula 904. A heat transfer mechanism may include a heater, a cooler, both, or a thermodynamic device that performs both functions, as depicted in FIG. 11. A rigid ejection member or pusher surface may include a plate, block, or rod, such as the vacuum pad 202 in a movable form, such as in FIG. 5A, or such as the ejector pins shown in FIG. 10E. A linkage may be rigid, or jointed, or elastomeric, and in cases of tension may include a cable, elastomeric connection, or the like. A conformal surface may include a concave, convex, or recessed portion, such as depicted in FIGS. 6A-6C. A relief surface may include peaks or ridges or bumps or raised portions as local maxima, e.g., as well as grooves as valleys. A flexible ejection member may include a bendable or stretchable sheet or web such as shown in FIG. 10H, or an inflatable member. A conveyor may include structures such as shown in FIGS. 10K-10M.

We claim:

1. An apparatus comprising:
a soft robotic actuator comprising a strain limiting layer and an inflatable elastomeric bladder configured to receive an inflation fluid, wherein the actuator is configured to bend about the strain limiting layer when partially or fully inflated with the inflation fluid; and
a vacuum pad comprising a plurality of holes through which a vacuum force may be applied to a target object,
wherein the actuator and vacuum pad are positioned so that, when the target object is held in place by the vacuum pad, the target object is graspable by the actuator when the actuator is in a fully or partially inflated state.

2. The apparatus of claim 1, further comprising an adjustable z-height post configured to adjust a distance between a top of the vacuum pad and a grasping tip of the soft robotic actuator.

3. The apparatus of claim 1, wherein the apparatus is mounted to a manifold and further comprising a compliant pad disposed between the vacuum pad and the manifold, the compliant pad configured to be compressed between the vacuum pad and the manifold.

4. The apparatus of claim 1, wherein the vacuum pad comprises a top plate configured to be placed in face-to-face contact with the target object, and wherein:
the top plate is substantially circular and flat, or
the top plate is concave, or
the top plate comprises a recessed portion in which the plurality of holes are disposed.

5. The apparatus of claim 1, wherein the vacuum pad comprises a top plate configured to be placed in face-to-face contact with the target object, and wherein the top plate comprises ridges and grooves formed between the ridges and the apparatus further comprises an air injector for injecting air into the grooves to release the target object.

6. The apparatus of claim 1, further comprising a release device configured to perform at least one of vibrating or emitting ultrasonic waves to release the target object.

7. The apparatus of claim 1, further comprising a release device configured to mechanically release the target object, the release device comprising at least one of an ejector bar, a pin, or a stretchable membrane.

8. The apparatus of claim 1, further comprising a pincer shaped and positioned to remove a dividing sheet from a surface of the target object.

9. A robot comprising:
a robotic arm;
a first end-of-arm tool comprising the apparatus of claim 1; and
a second end-of-arm tool comprising a spatula.

10. The robot of claim 9, further comprising a temperature sensor.

11. A method comprising:
approaching a target object at an initial location with a robotic end-of-arm tool, the tool comprising a soft robotic actuator comprising a strain limiting layer and an inflatable elastomeric bladder configured to receive an inflation fluid, wherein the actuator is configured to bend about the strain limiting layer when partially or fully inflated with the inflation fluid, and a vacuum pad comprising a plurality of holes through which a vacuum force may be applied to a target object;
contacting the target object with the vacuum pad;
activating a vacuum generator to apply a vacuum force to the target object;
actuating the actuator to cause the actuator to bend and grasp the target object with a grasping surface of the actuator; and
withdraw the tool from the initial location to move the target object.

12. The method of claim 11, further comprising moving the target object to a target area and releasing the target object, the releasing comprising:
deactuating the actuator, and
deactivating the vacuum generator to fully or partially remove the vacuum force.

13. The method of claim 12, wherein the releasing further comprises vibrating the target object.

14. The method of claim 12, wherein the releasing further comprises applying heat or cold to at least one of the target object or the vacuum pad.

15. The method of claim 12, wherein the releasing further comprises ejecting the target object from the vacuum pad using a mechanical release device.

16. The method of claim 12, wherein the releasing further comprises puffing air through the holes in the vacuum pad.

17. The method of claim 11, further comprising adjusting a height of the vacuum pad in a z-direction height of pad to adjust a position of the target object with respect to the grasping surface of the actuator.

18. The method of claim 11, wherein the target object is provided in a fixturing station, the fixturing station configured to elevate the target object to a consistent grasp height.

19. The method of claim 11, further comprising detecting a that the target object has been secured to the vacuum pad by determining that a fluid flow through the holes has been reduced or stopped, and actuating the actuator in response to the detecting.

20. The method of claim 11, further comprising:
moving the target object to a cooking station;
releasing the target object;
applying a temperature sensor to the target object to determine that the target object has reached a target temperature; and
withdrawing the target object from the cooking station based on the determining.

21. A soft robotic system for transporting an organic article, comprising:
a soft robotic gripper including at least two bendable members configured to apply a gripping force to the organic article;
a palm plate adjacent the two bendable members, the palm plate including at least one of an astrictive or a contiguitive mechanism configured to apply an attractive force biased toward the palm plate upon the organic article; and
an ejection mechanism adjacent the two bendable members configured to apply an ejection force biased away from the palm plate upon the organic article.

22. The soft robotic system according to claim 21, further comprising:
a gripper hub supporting the soft robotic gripper, palm plate, and ejection mechanism;
a fluid actuator fluidly connected to the at least two bendable members to cause the soft robotic gripper to open and close about the organic article; and
a motorized drive configured to relatively move the gripper hub and the organic article to be transported in at least one degree of freedom.

23. The soft robotic system according to claim 22, wherein the palm plate includes an astrictive mechanism including a perforated air table connected to a fluid actuator capable of reducing fluid pressure through the air table to attract the organic article to the palm plate.

24. The soft robotic system according to claim 22, further comprising:
a spatula member opposing the palm plate configured to scrape or support the organic article from a surface and to hold the organic article in a position to be gripped by the soft robotic gripper.

25. The soft robotic system according to claim 22, further comprising:
a heat transfer mechanism supported by the gripper hub configured to change the temperature of the palm plate adjacent the organic article.

26. The soft robotic system according to claim 23, the ejection mechanism further comprising:
a rigid ejection member configured to apply the ejection force directly to the organic article.

27. The soft robotic system according to claim 26, further comprising:
a guide mechanism to hold the rigid ejection member in different base positions to support differing thickness organic articles held against the rigid ejection member by the soft robotic gripper.

28. The soft robotic system according to claim 26, further comprising:
a linkage connecting the rigid ejection member to move the rigid ejection member together with an opening motion of at least one of the two bendable members to apply the ejection force.

29. The soft robotic system according to claim 26, further comprising:
a fluid actuator configured to apply fluid force to the rigid ejection member to apply the ejection force.

30. The soft robotic system according to claim 26, wherein the rigid ejection member penetrates through the palm plate and moves relative to the palm plate to apply the ejection force.

31. The soft robotic system according to claim 26, wherein the rigid ejection member includes a pusher surface, the pusher surface being moved by the ejection mechanism to apply the ejection force.

32. The soft robotic system according to claim 31, wherein the pusher surface includes an astrictive mechanism including a perforated air table connected to a fluid actuator capable of reducing fluid pressure through the perforated air table to attract the organic article to the pusher surface.

33. The soft robotic system according to claim 31, the pusher surface comprising a flat surface having a surface area at least 50% of the surface area of the palm plate.

34. The soft robotic system according to claim 31, the pusher surface comprising a conformal surface having a contour substantially matching an expected general shape of an organic article to be gripped by the soft robotic gripper.

35. The soft robotic system according to claim 31, the pusher surface comprising a relief surface having peaks configured to contact the organic article and valleys configured to maintain clearance between the pusher plate and the organic article.

36. The soft robotic system according to claim 23, the ejection mechanism further comprising:
a flexible ejection member configured to apply the ejection force.

37. The soft robotic system according to claim 36, further comprising:
a linkage connecting the flexible ejection member to move the flexible ejection member together with at least one of the two bendable members.

38. The soft robotic system according to claim 36, further comprising:
a mechanical actuator acting upon the flexible ejection member to bend the flexible ejection member to apply the ejection force, the mechanical actuator including at least one of a plunger, a swing arm, an eccentric cam, or a vibrating oscillator.

39. The soft robotic system according to claim 36, further comprising:
a conveyor translating the flexible ejection member to apply the ejection force as a shearing force.

40. The soft robotic system according to claim 38, further comprising:
at least one of an astrictive or a contiguitive mechanism acting via the flexible ejection member conveyed by the conveyor.

41. The soft robotic system according to claim 36, further comprising:
a fluid actuator configured to apply fluid force to the flexible ejection member to apply the ejection force.

42. The soft robotic system according to claim 37,
a strain limiting member integrated with the flexible ejection member configured to cause the flexible ejection member to bend substantially as a whole under the fluid pressure to apply the ejection force.

43. The soft robotic system according to claim 37,
a perforated member integrated with the flexible ejection member configured to cause the flexible ejection member to form convex protrusions in a plurality of locations under the applied fluid force to apply the ejection force.

44. The soft robotic system according to claim 43,
wherein the fluid actuator is further configured to apply a reduction in fluid pressure to cause the flexible ejection member to form concavities at the plurality of locations.

45. The soft robotic system according to claim 41, further comprising an accordion chamber that expands under the applied fluid force to apply the ejection force.
